(19) United States
(12) Patent Application Publication
(10) Pub. No.: US 2019/0382687 A1
(43) Pub. Date: Dec. 19, 2019

(54) LIQUID DETERGENT COMPOSITION

(71) Applicant: The Procter & Gamble Company, Cincinnati, OH (US)

(72) Inventors: Jean-Luc Philippe BETTIOL, Etterbeek (BE); Denis Alfred GONZALES, Brussels (BE); Pieter Jan Maria SAVEYN, Destelbergen (BE)

(21) Appl. No.: 16/427,703

(22) Filed: May 31, 2019

(30) Foreign Application Priority Data
Jun. 4, 2018 (EP) 18175694.1
Jan. 28, 2019 (EP) 19153872.7

(51) Int. Cl. C11D 3/386; C11D 1/12; C11D 1/75; C11D 1/62; C11D 3/382

(52) U.S. Cl. CPC C11D 3/38636; C11D 1/12; C11D 3/382; C11D 1/62; C11D 1/75

(57) ABSTRACT

The present invention is directed to a liquid detergent composition having enhanced suds boosting and/or increased suds longevity especially in the presence of greasy soils, preferably wherein the liquid detergent composition is a liquid hand dishwashing detergent composition. The composition includes a specific surfactant system including an anionic surfactant and a primary co-surfactant, and a potato-derived protein comprising a potato protein lipase preferably patatin, a protease inhibitor, a lipoxygenase, a phosphorylase, or mixtures thereof.

### REFERENCE TO A SEQUENCE LISTING

This application contains Sequence Listings in computer readable form. The computer readable form is incorporated herein by reference.

### FIELD OF THE INVENTION

The present invention relates to a liquid detergent composition comprising a specific surfactant system and a potato-derived protein comprising a potato protein lipase preferably patatin, a protease inhibitor, a lipoxygenase, a phosphorylase, or mixtures thereof, preferably wherein the liquid detergent composition is a liquid hand dishwashing detergent composition.

### BACKGROUND OF THE INVENTION

Liquid detergent compositions should provide good soil and/or grease cleaning while presenting a good sudsing profile in particular a long-lasting suds profile especially in the presence of greasy soils. Users usually see suds as an indicator of the performance of the liquid detergent composition. Moreover, the user of a liquid detergent composition may also use the sudsing profile and the appearance of the suds (e.g., density) as an indicator that the wash solution still contains sufficient active cleaning ingredients. This is particularly the case for manual washing, also referred to herein as hand-washing, where the user usually doses the liquid detergent composition depending on the suds remaining and renews the wash solution when the suds subsides or when the suds does not look thick enough. Thus, a liquid detergent composition, particularly a liquid hand dishwashing detergent composition that generates or maintains low density suds during the dishwashing process would tend to be replaced by the user more frequently than is necessary. Thus, it is desirable for a liquid detergent composition to provide a “good sudsing profile”, which includes good suds height and/or density as well as good suds duration (i.e., increased suds longevity) during the initial mixing of the composition with water and/or during the entire washing operation. In recent years, users also desire that the liquid hand dishwashing detergents are formulated with ingredients that will have minimal negative impact on the environment and/or the health of the users and with minimal costs. Suds can be formed and stabilized by surfactants and/or proteins (e.g., animal or vegetable proteins). By co-formulating with vegetable proteins, it is possible to reduce the levels of surfactants utilized and mitigate against the negative environmental impact often associated with the use of animal proteins while still maintaining a good sudsing profile.

Potato-derived proteins have been well characterized in the art. Typically, potato-derived proteins are classified into three categories: (i) the patatin family, highly homologous acidic 40-46 kDa glycoproteins (40-60 wt % of the potato-derived proteins), (ii) basic 4-25 kDa protease inhibitors (40-60 wt % of the potato-derived proteins), and (iii) other high molecular weight protein (e.g.: 10-20% of the potato-derived proteins like phosphorylase, lipoxygenase, etc.) (Pots et al., J. Sci. Food. Agric. 1999, 79, 1557-1564). The patatin is known to have lipase activity and can be readily isolated with high purity and/or yield (WO2008/069650). The potato-derived proteins, including the potato protein lipase patatin, have been mainly used as feedstocks for animals, as foam stabilizing agents in non-soiled beverage compositions (e.g., beer, WO2010/062174A1), and as alternative source of macronutrients (proteins) in nutritional compositions (WO2015/187817). However, the inclusion of potato-derived proteins, particularly the potato protein lipase patatin, in the context of liquid hand dishwashing detergent compositions for improving sudsing profile, particularly increased suds longevity especially in the presence of greasy soils, has not been disclosed.

Accordingly, the need remains for an improved liquid detergent composition comprising a potato-derived protein and a specific surfactant system, which provides a good sudsing profile, in particular enhanced suds boosting and/or increased suds longevity, especially in the presence of greasy soils. The composition may also provide good cleaning, particularly good grease emulsification. It is desirous to reduce the levels of surfactants in the composition versus traditional formulations without negatively impacting sudsing, grease cleaning and/or emulsification profile. The Applicant discovered that some or all of the above-mentioned needs can be at least partially fulfilled through the improved detergent composition as described herein below.

EP3243897 A1 relates to the use of a detergent composition comprising a fatty acid-transforming enzyme to impart suds longevity in a washing process. U.S. Pat. No. 4,746,454 A relates to a cleaning composition efficient for washing dishes and hands, having an embodiment of the composition which contains about 88.5% raw potato pulp, about 1.0% sodium bisulphite, about 0.5% sodium stearyl fumerate, about 5.0% 190 proof denatured alcohol, about 5.0% nonionic surfactant, and a trace of artificial food coloring and fragrance. EP3269729 A1 relates to a detergent composition comprising a Bs1A-like protein and a surfactant system.

### SUMMARY OF THE INVENTION

The present invention meets one or more of these needs based on the surprising discovery that by formulating a liquid detergent composition comprising a specific surfactant system working in synergy with a potato-derived protein. Such a composition exhibits good sudsing profile, particularly desirable suds volume and/or increased suds longevity, especially in the presence of greasy soils. The composition also provides good cleaning and emulsification benefits.

According to a first aspect, the present invention is directed to a liquid detergent composition comprising: a) from 1 wt % to 60 wt % by weight of the liquid detergent composition of a surfactant system, wherein the surfactant system comprises:
i) an anionic surfactant, preferably an anionic sulfate surfactant, more preferably an anionic surfactant selected from the group consisting of alkyl sulfate, alkyl alkoxy sulfate, and mixtures thereof;
ii) a primary co-surfactant selected from the group consisting of an amine oxide surfactant, a betaine surfactant, and mixtures thereof; and
b) from 0.005 wt % to 10 wt % of the liquid detergent composition of a potato-derived protein, wherein the potato-derived protein comprises, based on active protein:
i) from 10 wt % to 80 wt % by weight of the total potato-derived protein of a protein belonging to the patatin family;
ii) from 10 wt % to 75 wt % by weight of the total potato-derived protein of a protein belonging to the protease inhibitor family; and
iii) from 10 wt % to 75 wt % by weight of the total potato-derived protein of a protein belonging to the lipoxygenase family; and
iv) below 15% by weight of the total potato-derived protein of a protein belonging to the phosphorylase family.
   The separation, identification, and measurement of the weight percentages of the proteins can be achieved using methods known to those skilled in the art, such as via ultra-filtration and chromatography, as described in “Membrane-based techniques for the separation and purification of proteins: An overview”, Advances in Colloid and Interface Science 145 (2009) 1-22, and “Protein Purification: Principles, High Resolution Methods, and Applications, 3rd Edition.”, 2011, Janson (Ed.), ISBN: 978-0-471-74661-4.

Preferably, the liquid detergent composition is essentially free, preferably free, of animal-, fungal- and/or bacterial-derived proteins. “Essentially free” means that there is no intention to include any animal-, fungal- and/or bacterial-derived proteins in the liquid detergent composition. It has been surprisingly found that the liquid detergent composition of the present invention creates long lasting suds under a hand dishwashing operation, especially in the presence of greasy soils.

In another aspect, the present invention is directed to a method of manually washing dishware comprising the steps of delivering a liquid detergent composition according to any of the preceding claims to a volume of water to form a wash liquor and immersing the dishware in the wash liquor, or delivering a liquid detergent composition according to any of the preceding claims directly onto the dishware or cleaning implement and using the cleaning implement to clean the dishware. When the composition of the invention is used according to this method a good sudsing profile, with a long-lasting effect is achieved, especially in the presence of greasy soils.

There is also provided the use of a liquid detergent composition of the claims to provide increased suds longevity of the liquid detergent composition, especially in the presence of greasy soils, preferably wherein the liquid detergent composition is a liquid hand dishwashing detergent composition.

One aim of the present invention is to provide a liquid detergent composition which can exhibit good sudsing profile, in particular enhanced suds boosting and/or increased suds longevity, especially in the presence of greasy soils, preferably over the entire dishwashing process, preferably wherein the liquid detergent composition is a liquid hand dishwashing detergent composition.

Another aim of the present invention is to provide such a liquid detergent composition having good tough food cleaning (e.g., cooked-, baked- and burnt-on soils) and/or good grease cleaning.

Yet another aim of the present invention is to provide a liquid detergent composition, comprising a potato-derived protein which functions to increase suds longevity and facilitate the reduction of surfactants in the formulation. Thus, it is an advantage of the invention to minimize production costs and/or reduce negative environmental impact.

A further aim of the present invention is to provide such a liquid detergent composition comprising a potato-derived protein, in a form which is water soluble and/or transparent resulting in improved water solubility and/or transparency of the liquid detergent composition, particularly in an aqueous environment.

Yet a further aim of the present invention is to provide such a liquid detergent composition comprising a potato derived protein or blend of potato derived proteins resulting in a liquid detergent composition that has low or is essentially free of phytic acid and/or protein-bound carbohydrate and/or lipids or protein-bound lipids. “Essentially free” means that there is no intention to include any phytic acid and/or protein-bound carbohydrate and/or lipids in the liquid detergent composition. This is believed to contribute to improved water solubility of the composition and/or improved potato-derived protein performance to enhance sudsing profile.

The elements of the liquid detergent composition of the invention described in relation to the first aspect of the invention apply mutatis mutandis to the other aspects of the invention. These and other features, aspects and advantages of the present invention will become evident to those skilled in the art from the detailed description which follows.

### DETAILED DESCRIPTION OF THE INVENTION

### Definitions

As used herein, the articles “a” and “an” when used in a claim, are understood to mean one or more of what is claimed or described.

As used herein, the term “amino acid identity” means the identity between a polypeptide subunit or a protomer of the potato-derived protein and the reference amino acid sequence and is expressed in terms of the identity or similarity between the subunit or the protomer and the sequence. Sequence identity can be measured in terms of percentage identity; the higher the percentage, the more identical the sequences are. The percentage identity is calculated over the length of comparison. For example, the amino acid identity of a patatin protein is typically calculated over the entire length of a subunit or protomer aligned against the entire length of the reference sequence (e.g., SEQ ID NOs: 1-10). Methods of alignment of sequences for comparison are well known in the art and identity can be calculated by many known methods. Various programs and alignment algorithms are described in the art. It should be noted that the terms ‘sequence identity’ and ‘sequence similarity’ can be used interchangeably. For polypeptide sequence comparison the following settings can be used: Alignment algorithm: Needleman and Wunsch, J. Mol. Biol. 1970, 48: 443-453. As a comparison matrix for amino acid similarity the Blosum62 matrix is used (Henikoff S. and Henikoff J. G., P.N.A.S. USA 1992, 89: 10915-10919). The following gap scoring parameters are used: Gap penalty: 12, gap length penalty: 2, no penalty for end gaps.

As used herein the term “animal protein” means protein that is derived from meat, or dairy products such as milk, eggs and the like.

As used herein the term “bacterial derived protein” means protein that are produced by bacteria.

As used herein the term “fungal derived protein” means protein that is derived from fungi.

As used herein, “potato-derived protein” or “potato protein” means protein that is derived from potato. Furthermore, the term also mean a protein composition derived from potato sources that is uncontaminated by animal, fungal or bacterial products or any animal-, fungal- or bacterial-derived peptides that are derived from the fermentation media or the purification media.

As used herein, the term “dishware” includes cookware and tableware.

As used herein the term “enhanced suds boosting” means a higher volume of suds is generated upon the dissolution of the liquid detergent composition in a washing solution for a composition comprising a potato-derived protein and a specific surfactant system of the present invention, as compared with the suds longevity provided by the same composition and process in the absence of the potato-derived protein and/or the specific surfactant system of the present invention.

As used herein, the term “essentially free” when used to describe a component means that there is no intention to include any of the component in the liquid detergent composition.

As used herein, the term “hand dishwashing detergent composition” refers to a composition or formulation designed for cleaning dishware. The composition is commercially positioned for manual-washing of dishware. Preferred compositions are in the form of a liquid.

As used herein the term “increased suds longevity” means an increase in the duration of visible suds in a washing process for cleaning soiled dishware in this case when using the liquid detergent composition comprising a potato-derived protein and a specific surfactant system of the present invention, compared with the suds longevity provided by the same liquid detergent composition in the absence of the potato-derived protein and/or the specific surfactant system of the present invention. As used herein the term “protein isolate” means a protein that has been isolated from a plant source based on well-known extraction processes to those skilled in the art, such as for example alkali extraction and acid preparation, protein micellation method (PMM), or low pH extraction combined with protein isolate preparation (Wanadundara et al., OCL 2016, 23(4) D407). Depending on the method of protein extraction employed, the final product could vary in terms of the protein content, type and extent of interaction with non-protein components. Isolates are more pure than other forms (e.g., concentrates) as other non-protein components have been removed to “isolate” the protein of interest. Preferably, the protein isolate has a protein content (as determined by Kjeldahl Nx6.25) of at least about 80 wt % or more, preferably about 90 wt % or more, more preferably 100%, is substantially undenatured (as determined by differential scanning calorimetry) and has a low residual fat content of less than about 1 wt %.

As used herein the term “protomer” means the structural unit of an oligomeric protein. It is the smallest unit composed of at least two different protein chains that form a larger heterooligomer by association of two or more copies of this unit.

As used herein the term “subunit” means a single protein molecule that assembles (or “co-assembles”) with other protein molecules to form a protein complex.

As used herein the term “sudsing profile” refers to the properties of a liquid detergent composition relating to suds character, preferably generated during the hand dishwashing process. For example, the sudsing profile of a liquid detergent composition includes but is not limited to the suds generation upon dissolving of the liquid detergent composition, and the volume and retention of the suds during the hand dishwashing process.

It is understood that the test methods that are disclosed in the Test Methods Section of the present application must be used to determine the respective values of the parameters of Applicants' inventions as described and claimed herein.

In all embodiments of the present invention, all percentages are by weight of the total composition, as evident by the context, unless specifically stated otherwise. All ratios are weight ratios, unless specifically stated otherwise, and all measurements are made at 25° C., unless otherwise designated.

### Detergent Composition

The Applicant has surprisingly discovered a new way of formulating a liquid detergent composition to provide good sudsing profile, particularly increased suds longevity, preferably in the presence of greasy soil. Essentially, the solution is to formulate a specific surfactant system which synergizes with a potato-derived protein. In fact, the Applicant has discovered that when the specific surfactant system is co-formulated with the potato-derived protein, increased suds longevity, especially in the presence of greasy soil, is obtained. While not wishing to be bound by theory, it is believed that the specific surfactant system containing the potato-derived protein may more easily go to the air-water interface and remain in the suds film lamellae due to its specific physical properties. As a result, the longevity of the suds is increased due to the surfactant-potato-derived protein interactions that form strong continuous interfacial membrane that stabilizes the suds particles at the air-water interface. It is also believed that the potato protein lipase (e.g., patatin) can destroy lipids and protein-bound lipids equally, which in both case is beneficial for suds mileage. In addition, it is also believed that the potato protein lipoxygenase may hydrate the fatty acids, especially the unsaturated fatty acids which is equally beneficial for the suds mileage due to the fact that fatty acids and especially saturated fatty acids destroy the foam interface unlike the hydrated version of the fatty acids. Therefore, the potato proteins are ideally set to help suds mileage by acting on several suds-favoring mechanisms.

In addition, the Applicant has discovered that the potato-derived protein and surfactant system in the liquid detergent composition also provides enhanced suds boosting benefit. Preferably, the liquid detergent composition of the invention also provides good grease removal, in particular good uncooked grease removal.

Preferably, the liquid detergent composition of the present invention is a manual (i.e., hand) dishwashing composition. It typically contains from about 30 wt % to about 95 wt %, preferably from about 40 wt % to about 90 wt %, more preferably from about 50 wt % to about 85 wt % by weight of the liquid detergent composition of a liquid carrier in which the other essential and optional components are dissolved, dispersed or suspended. One preferred component of the liquid carrier is water.

Preferably, the liquid detergent composition of the present invention comprises a phytic acid content of about 0.5 wt % or less, preferably about 0.2 wt % or less, preferably about 0.1 wt % or less, preferably about 0.01 wt % or less by weight of the liquid detergent composition, most preferably the liquid detergent composition is essentially free, preferably free, of the phytic acid. Potatoes contain phytic acid. Phytic acid (i.e., myo-inositol 1,2,3,4,5,6-hexakis (dihydrogen phosphate)) is a form of phosphorus (P) in potatoes which is stored in the form of phytate salts. The term “phytic acid” as used herein includes such phytate salt forms. Depending on the potato type, the content of phytic acid may range from about 0.3 wt % to about 10 wt %. Extraction of the potato results in the presence of phytic acid in the potato protein isolate recovered. Phytic acid has a negative impact on the potato protein isolates, specifically, the presence of phytic acid reduces the potato protein solubility and/or flexibility thereby preventing its absorption at the air-water interface. As the quantity of phytic acid in the potato protein isolate increases, the negative impact of the potato protein performance increases. Thus, it is desirable to incorporate potato protein isolates that have substantially reduced or are essentially free of phytic acid. Reduced amounts of phytic acid content in the potato protein isolates from extraction of the potato may be achieved by extraction at temperatures above 50° C., in the presence of CaCl₂) or MgCl₂, and/or in the presence of from about 0.01% to about 1% phytase. Following these actions, the precipitated phytate can be removed from the potato protein solution such as by centrifugation.

The liquid detergent composition of the present invention preferably comprises a potato protein-bound carbohydrate content of about 2 wt % or less, preferably about 1 wt % or less, preferably about 0.5 wt % or less, preferably about 0.1 wt % or less, preferably about 0.01 wt % or less by weight of the liquid detergent composition, most preferably the liquid detergent composition is essentially free, preferably free, of the protein-bound carbohydrate. The term “potato protein-bound carbohydrate” as used herein means an isolated potato protein that has carbohydrate bound (chemically or physically) to it. Carbohydrate bound potato proteins have decreased performance because the carbohydrate screens the active sites of the potato proteins and reduces the potato protein solubility, flexibility and/or mobility thereby preventing its absorption at the air-water interface. Therefore, it is desirable to limit the level of isolated potato proteins that are bound to carbohydrates in the detergent composition. Reduced amounts of potato protein-bound carbohydrates in the potato protein isolates from extraction of the potato may be achieved by extraction with from about 0.01% to about 1% of a carbohydrate hydrolyzing enzyme, preferably carbohydrase. The carbohydrate residues can then be separated from the potato protein isolate fractions such as by membrane or dialysis filtration.

Preferably the pH of the liquid detergent composition, measured as a 10% product concentration (i.e., dilution) in distilled water at 20° C., is adjusted to between about 6 and about 14, more preferably between about 7 and about 12, more preferably between about 7.5 and about 10. The pH of the liquid detergent composition can be adjusted using pH modifying ingredients known in the art.

The liquid detergent composition of the present invention can be Newtonian or non-Newtonian, preferably Newtonian. The liquid detergent composition has a viscosity of from about 10 to about 10,000 mPa·s, preferably from about 100 to about 5,000 mPa·s, more preferably from about 300 to about 2,000 mPa·s, or most preferably from about 500 to about 1,500 mPa·s. Viscosity is measured with a Brookfield DV-II+Pro Viscometer using spindle 31 at 12 RPM at 20° C.

The liquid detergent composition is preferably a laundry or hard surface cleaning liquid detergent composition, more preferably a liquid hand dishwashing detergent composition.

### Potato-Derived Proteins

Potato is the world's fourth most grown vegetable after rice, wheat and corn. Potato tuber contains ˜1.5% by weight of protein. To date, potato proteins have been used as nutritional supplements (i.e., food applications), feedstocks for animals, and foaming agents in beverage compositions (e.g., beer). The Applicant has surprisingly discovered that by formulating with potato proteins, it is possible to obtain a good sudsing profile, in particular enhanced suds boosting and/or increased suds longevity, in liquid detergent compositions comprising a specific surfactant system, especially in the presence of greasy soils.

Potato proteins tend to be of superior quality versus other vegetable proteins because potato proteins combine useful protein features such as high solubility, high mobility, and useful enzymatic activities. Potato protein contain a relatively high content of small molecular weight proteins which is equally an asset for foaming. Consequently, it features superior solubility and mobility which are key factors responsible for providing the good sudsing profile, particularly improved suds stability, when formulated into liquid detergent compositions of the present invention. Without wishing to be bound by theory, it is believed that the potato proteins have enzymatic properties such as lipase, especially phospholipase and lipoxygenase activities, which are specifically targeting lipids and fatty acids to promote the good sudsing profile, particularly improved suds stability. Furthermore, it is believed that the potato protein contains high level of cationic charged lysine that help the enzyme to form a stabilized layer at the suds interface.

The four predominant potato protein sub-families include: i) 40%-60% potato protein lipase (e.g., patatin), ii) 40%-60% potato protease inhibitor, iii) 1%-5% potato lipoxygenase, and iv) 10%-20% potato phosphorylase, by weight of the potato protein. Preferably, an indicative optimal ratio of potato protein for improving sudsing stability is ˜25% patatin, ˜45% Protease inhibitor, ˜25% Lipoxygenase and <5% Phosphorylase, by weight of the potato protein. It will be understood that the relative ratios of these different potato proteins may vary depending on the extraction method and/or further treatment processes. There are numerous extraction methods for potato proteins, including for example, Waglay et al., Food Chemistry 142, (2014) 373-382. A preferred extraction method includes the extraction of protein in gradient of saline solution followed by protein micellization precipitation. There are numerous processing methods for potato proteins, including for example, via ultra or membrane filtration. Preferably the methods used to extract and/or process the potato proteins are relatively mild so as to preserve the enzymatic properties of the potato proteins. Preferably, the potato proteins of the present invention have undergone selective extraction and/or process methods to optimize the ratio of these potato proteins for optimal sudsing performance.

The use of potato protein isolates in a highly pure form eliminates most of the undesirable interference from non-potato protein components and allows for targeted formulations with mixtures and ratios of specific potato proteins. Therefore, it is preferred that the potato proteins of the present invention are used in the form of potato protein isolates. Preferably, the potato protein isolates have been extracted by protein precipitation (e.g.: with or without precipitating agent, with or without inorganic colloidal, polymers, especially carbohydrates, etc.), protein micellization process and/or ultra-filtration, optionally followed by re-blending of the separated potato protein isolate fractions to achieve the desired mixture and ratio of the potato protein lipase (patatin), the potato protease inhibitor, the potato lipoxygenase, and the potato phosphorylase, in order to maximize sudsing performance.

The liquid detergent composition of the present invention comprises a potato derived protein, wherein: b) the total potato-derived protein comprises, based on active protein:
i) from 10 wt % to 80 wt %, more preferably from 30 wt % to 60 wt %, by weight of the total potato-derived protein of a protein belonging to the patatin family;
ii) from 10 wt % to 75 wt %, more preferably from 30 wt % to 50 wt %, by weight of the total potato-derived protein of a protein belonging to the protease inhibitor family;
iii) from 10 wt % to 75 wt %, more preferably from 30 wt % to 50 wt %, by weight of the total potato-derived protein of a protein belonging to the lipoxygenase family; and
iv) below 15%, more preferably below 5%, by weight of the total potato-derived protein of a protein belonging to the phosphorylase family;
   preferably wherein the sum total weight percentage of i), ii), iii) and iv) equals 100 wt % by weight of the total potato-derived protein.

Potato-derived proteins and protein isolates are commercially available, such as Tubermine® FV (supplied by Dadelos Agricola), or can be extracted and characterised, for instance using the methodologies described by Amanda Waglay and Salwa Kaboune in: “Potato protein isolates: Recovery and characterization of their properties”, Food Chemistry, vol. 142, January 2014, pages 373-382.

Potato Protein Lipase (Patatin)

The potato-derived protein is preferably a potato-derived protein isolate comprising a potato protein lipase. Preferably, the potato protein lipase is a patatin. The patatin is a family of glycoproteins considered to be a storage protein and constitutes a highly homogenous group of isoforms derived from dimer glycoproteins with molecular weight ranging of 40-46 kDa. Patatin has broad lipase activities and can hydrolyze a wide range of acyl-lipid and phospholipids. The patatin makes up about 40% of the soluble proteins in potato tubers. The patatin protein can be obtained by extraction with high purity from potato fruit juice according to the methods disclosed in WO2008/069650 (Avebe) or WO2014/007621 (Avebe). Alternatively, the patatin protein can be extracted from commercially available protein concentrates or isolates e.g.: Tubermine® FV (Roquette, France), or from other suppliers e.g.: Avebe, Akv, KMc, Emsland, etc. Specifically, the patatin protein is proposed for use in applications for suds stabilization in liquid detergent compositions. Without wishing to be bound by theory, it is believed that the patatin can destroy lipids and protein-bound lipids equally which aids in suds stability because foam-destroying Lipids and especially phospholipid are transformed in foam-stabilizing lyso-lipid and especially lyso-phospholipid.

Preferably, the liquid detergent composition of the present invention comprises a patatin, wherein the patatin has at least 50%, preferably at least 60%, preferably at least 70%, preferably at least 80%, preferably at least 85%, preferably at least 90%, preferably at least 95%, preferably at least 98% or even 100% amino acid identity as calculated over the entire length of the sequence aligned against the entire length of a Patatin protein (SEQ ID NOs: 1-10).

Preferably, the patatin of the present invention has a phospholipase activity, preferably a phospholipase A1 or A2 activity, more preferably a phospholipase A2 activity. Typically, phospholipids are responsible for promoting suds instability even at ultra low levels. Conversely, patatin is able to transform these phospholipids into lyso-phospholipids, which in turn are capable of fostering suds, even at ultra low levels of the patatin.

Potato Protease Inhibitor

The potato protease inhibitor protein is also considered to be a storage protein with a molecular weight range of 4-25 kDa. The potato protease inhibitor can be divided into 3 heterogenous sub-groups according to their increasing molecular weights: subclass I (<10 kDa), II (10-15 kDa), and III (20-25 kDa). The most abundant protease inhibitors are believed to be dimeric protein containing 2 subunits of named Protease inhibitor 2 (“PI-2”) or a Potato serine protease inhibitor belonging to the Kunitz-type family. Potato protease inhibitor are proteins that can indeed inhibit a variety of protease as well as other enzymes. Due to its low molecular weight, the potato protease inhibitor is capable of achieving fast and large suds volume by absorbing rapidly at the air/water interface. Further, the potato protease inhibitor can reach quickly and stabilize the air-water interface which allow the slower larger proteins to also reach the air/water interface and further enhance suds stabilization.

The potato protease inhibitor can be obtained by extraction from potato fruit juice according to the method disclosed in WO2008/069649A1. Alternatively, the potato protease inhibitor can also be extracted from commercial sources of potato protein concentrates or isolates available from Roquette, Avebe, Akv, KMc, Emsland, etc.

Preferably, the liquid detergent composition of the present invention may comprise a protease inhibitor, wherein the protease inhibitor has at least 50%, preferably at least 60%, preferably at least 70%, preferably at least 80%, preferably at least 85%, preferably at least 90%, preferably at least 95%, preferably at least 98% or even 100% amino acid identity as calculated over the entire length of the sequence aligned against the entire length of a Protease Inhibitor protein (SEQ ID NOs: 11-22).

### Potato Lipoxygenase

Potatoes Lipoxygenases (“LOXs”) are a structurally related family of non-heme iron-containing enzymes with a molecular weight range of 90-110 kDa. They belong to the family of Lipoxygenases (E.C. 1.13.11.-) (J. Biological Chemistry, Vol. 271, n. 35, p. 21012, August 1996; and Biochem J. n. 174, p 431, 1971). It is believed that the potato lipoxygenases contain at least LOX1 and/or LOX2 and/or LOX3 that oxidase fatty acid, preferably unsaturated fatty acids. Preferably the lipoxygenase has an unsaturated fatty acid transforming activity, preferably wherein the unsaturated fatty acid is selected from the group consisting of linolenic acid, linoleic acid and arachidonic acid (“ARA”), with the inclusion of hydroxyl groups in various carbon position of the fatty acids. Fatty acids and especially unsaturated fatty acids are believed to promote suds collapse even at ultra low levels. Conversely, hydrated fatty acids, e.g., after conversion via lipoxygenase, are believed to help suds stability even at low levels. Potato lipoxygenases can be directly extracted from potato tuber juice via standard extraction/isolation methods known to those skilled in the art, or alternatively is commercially available from Cayman Chemical Company (Michigan, US).

Preferably, the liquid detergent composition of the present invention may comprise a lipoxygenase, wherein the lipoxygenase has at least 50%, preferably at least 60%, preferably at least 70%, preferably at least 80%, preferably at least 85%, preferably at least 90%, preferably at least 95%, preferably at least 98% or even 100% amino acid identity as calculated over the entire length of the sequence aligned against the entire length of a Lipoxygenase protein (SEQ ID NOs: 29-38).

Potato Phosphorylase

Potato phosphorylase (E.C. 2.4.1.1) belongs to the family of high molecular weight (>80 kDa) potato proteins and is involved in the production of starch. While the large molecular weight and protein nature of potato phosphorylase may be helpful in sudsing, it is preferred that the liquid detergent compositions of the present invention are formulated with low levels of this protein in order to not promote protein aggregation and insolubility of the protein blend. Potato phosphorylase can be directly extracted from potato tuber juice via standard extraction/isolation methods known to those skilled in the art, or alternatively can be extracted from commercially protein concentrate or isolate available from Roquettes, Avebe, Akv, KMc, Emsland, etc.

Preferably, the liquid detergent composition of the present invention may comprise a phosphorylase, wherein the phosphorylase has at least 80%, preferably at least 85%, preferably at least 90%, preferably at least 95%, preferably at least 98% or even 100% amino acid identity as calculated over the entire length of the sequence aligned against the entire length of a Phosphorylase protein (SEQ ID NOs: 23-28).

### Surfactant System

The liquid detergent composition of the present invention comprises a surfactant system. Preferably the liquid detergent composition comprises from about 1 wt % to about 60 wt %, preferably from about 5 wt % to about 50 wt %, more preferably from about 8 wt % to about 45%, even more preferably from about 15 wt % to about 40 wt %, by weight of the total composition of a surfactant system.

The surfactant system of the liquid detergent composition of the present invention comprises an anionic surfactant and a primary co-surfactant selected from the group consisting of amine oxide surfactant, betaine surfactant, and mixtures thereof. Preferably, the composition preferably comprises anionic surfactant and the primary co-surfactant system in a ratio of from less than about 10:1, preferably less than about 9:1, more preferably from about 5:1 to about 1:1, more preferably from about 4:1 to about 2:1, preferably from about 3:1 to about 2.5:1.

Preferably, the surfactant system for the liquid detergent composition of the present invention comprises from about 50 wt % to about 85 wt %, preferably from about 55 wt % to about 80 wt %, more preferably from about 60 wt % to about 75 wt % by weight of the surfactant system of an anionic surfactant. The anionic surfactant can be any anionic cleaning surfactant, preferably selected from sulfate and/or sulfonate anionic surfactants, most preferably sulfate anionic surfactant. HLAS (linear alkylbenzene sulfonate) would be the most preferred sulfonate anionic surfactant. Especially preferred anionic surfactant is selected from the group consisting of alkyl sulfate, alkyl alkoxy sulfate, and mixtures thereof, and preferably wherein the alkyl alkoxy sulfate is an alkyl ethoxy sulfate. Preferred anionic surfactant is an alkyl ethoxy sulfate with a mol average ethoxylation degree of less than about 5, preferably less than about 3, more preferably less than about 2 and more than about 0.5 and preferably wherein the alkyl ethoxy sulfate has an average alkyl carbon chain length of from about 8 to about 16, preferably from about 12 to about 15, more preferably from about 12 to about 14. Preferably, the alkyl ethoxy sulfate has an average level of branching of from about 5% to about 60%, preferably from about 10% to about 55%, more preferably from about 15% to about 50%, even more preferably from about 20% to about 45%, and most preferably from 25% to 45%.

The average alkoxylation degree is the mol average alkoxylation degree of all the components of the mixture (i.e., mol average alkoxylation degree) of the anionic surfactant. In the mol average alkoxylation degree calculation the weight of sulfate anionic surfactant components not having alkoxylate groups should also be included.

Mol average alkoxylation degree=(x1*alkoxylation degree of surfactant 1+x2*alkoxylation degree of surfactant 2+ . . . )/(x1+x2+ . . . )

wherein x1, x2, . . . are the number of moles of each sulfate anionic surfactant of the mixture and alkoxylation degree is the number of alkoxy groups in each sulfate anionic surfactant.

The average level of branching is the weight average % of branching and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the composition of the invention. In the weight average branching degree calculation the weight of anionic surfactant components not having branched groups should also be included.

Suitable examples of commercially available sulfates include, those based on Neodol alcohols ex the Shell company, Lial—Isalchem and Safol ex the Sasol company, natural alcohols ex The Procter & Gamble Chemicals company. Suitable sulfonate surfactants for use herein include water-soluble salts of C8-C18 alkyl or hydroxyalkyl sulfonates; C11-C18 alkyl benzene sulfonates (LAS), modified alkylbenzene sulfonate (MLAS); methyl ester sulfonate (MES); and alpha-olefin sulfonate (AOS). Those also include the paraffin sulfonates may be monosulfonates and/or disulfonates, obtained by sulfonating paraffins of 10 to 20 carbon atoms. The sulfonate surfactant also includes the alkyl glyceryl sulfonate surfactants.

Preferably the surfactant system for the liquid detergent composition of the present invention comprises from about 1 wt % to about 40 wt %, preferably from about 6 wt % to about 32 wt %, more preferably from about 8 wt % to about 25 wt % by weight of the total liquid detergent composition of an anionic surfactant.

Preferably, the surfactant system of the liquid detergent composition of the present invention comprises a primary co-surfactant system, wherein the primary co-surfactant system is preferably selected from the group consisting of amine oxide, betaine, and mixtures thereof. Preferably, the surfactant system for the liquid detergent composition of the present invention comprises from about 15 wt % to about 50 wt %, preferably from about 20 wt % to about 45 wt %, more preferably from about 25 wt % to about 40 wt %, by weight of the surfactant system of a primary co-surfactant system. Preferably the liquid detergent composition comprises from about 0.01 wt % to about 20 wt %, preferably from about 0.2 wt % to about 15% wt, more preferably from about 0.5 wt % to about 10 wt % by weight of the liquid detergent composition of an amine oxide and/or a betaine surfactant, more preferably an amine oxide surfactant.

Preferably the primary co-surfactant system is an amine oxide surfactant. Preferably, the primary co-surfactant system is an amine oxide surfactant selected from the group consisting of linear or branched alkyl amine oxide, linear or branched alkyl amidopropyl amine oxide, and mixtures thereof, preferably linear alkyl dimethyl amine oxide, more preferably linear C10 alkyl dimethyl amine oxide, linear C12-C14 alkyl dimethyl amine oxides and mixtures thereof, most preferably C12-C14 alkyl dimethyl amine oxide. Preferably, the liquid detergent composition comprises anionic surfactant and amine oxide surfactant in a ratio of less than about 9:1, more preferably from about 5:1 to about 1:1, more preferably from about 4:1 to about 2:1, preferably from about 3:1 to about 2.5:1. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least about 50 wt %, more preferably at least about 75 wt % to about 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as a C1 alkyl.

Preferably the amine oxide surfactant is a mixture of amine oxides comprising a low-cut amine oxide and a mid-cut amine oxide. The amine oxide of the liquid detergent composition of the invention then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls or mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof.

In a preferred low-cut amine oxide for use herein R3 is n-decyl. In another preferred low-cut amine oxide for use herein R1 and R2 are both methyl. In an especially preferred low-cut amine oxide for use herein R1 and R2 are both methyl and R3 is n-decyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Liquid detergent compositions comprising R7R8R9AO tend to be unstable and do not provide very suds mileage.

Preferably the primary co-surfactant system is a betaine surfactant. Suitable examples of betaine surfactants include betaines, such as alkyl betaines, alkylamidobetaine, amidazoliniumbetaine, sulfobetaine (INCI Sultaines) as well as the Phosphobetaine and preferably meets formula (I):

R1-[CO—X(CH2)n]x-N+(R2)(R3)-(CH2)m-[CH(OH)—CH2]y-Y— (I)

wherein:
R1 is a saturated or unsaturated C6-22 alkyl residue, preferably C8-18 alkyl residue, in particular a saturated C10-16 alkyl residue, for example a saturated C12-14 alkyl residue;
X is NH, NR4 with C1-4 Alkyl residue R4, 0 or S;
n is a number from 1 to 10, preferably 2 to 5, in particular 3;
x is 0 or 1, preferably 1;
R2 and R3 are independently a C1-4 alkyl residue, potentially hydroxy substituted such as a hydroxyethyl, preferably a methyl;
m is a number from 1 to 4, in particular 1, 2 or 3;
y is 0 or 1; and
Y is COO, SO3, OPO(OR5)O or P(O)(OR5)O, whereby R5 is a hydrogen atom H or
a C1-4 alkyl residue.

Preferred betaines are the alkyl betaines of the formula (Ia), the alkyl amido propyl betaine of the formula (Ib), the Sulfo betaines of the formula (Ic), and the Amido sulfobetaine of the formula (Id);

R1-N+(CH3)2-CH2COO— (Ia)

R1-CO—NH(CH2)3-N+(CH3)2-CH2COO— (Ib)

R1-N+(CH3)2-CH2CH(OH)CH2SO3- (Ic)

R1-CO—NH—(CH2)3-N+(CH3)2-CH2CH(OH)CH2SO3- (Id)

in which R1 has the same meaning as in formula I. Particularly preferred betaines are the Carbobetaine [wherein Y—═COO—], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milk=idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines. A preferred betaine is, for example, Cocoamidopropylbetaine.

Preferably, the surfactant system of the liquid detergent composition of the present invention further comprises from about 1 wt % to about 25 wt %, preferably from about 1.25 wt % to about 20 wt %, more preferably from about 1.5 wt % to about 15 wt %, most preferably from about 1.5 wt % to about 5 wt %, by weight of the surfactant system of a secondary co-surfactant system preferably comprising a non-ionic surfactant. Preferably the non-ionic surfactant is an alkyl ethoxylated non-ionic surfactant, preferably comprising on average from about 9 to about 15 preferably from about 10 to about 14 carbon atoms in its alkyl chain and on average from about 5 to about 12, preferably from about 6 to about 10, most preferably from about 7 to about 8, units of ethylene oxide per mole of alcohol.

Suitable non-ionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred non-ionic surfactants are the condensation products of guerbet alcohols with from 2 to 18 moles, preferably 2 to 15, more preferably 5-12 of ethylene oxide per mole of alcohol. Preferably, the non-ionic surfactants are an alkyl ethoxylated surfactants, preferably comprising from 9 to 15 carbon atoms in its alkyl chain and from 5 to 12 units of ethylene oxide per mole of alcohol. Other suitable non-ionic surfactants for use herein include fatty alcohol polyglycol ethers, alkylpolyglucosides and fatty acid glucamides, preferably alkylpolyglucosides. Preferably the alkyl polyglucoside surfactant is a C8-C16 alkyl polyglucoside surfactant, preferably a C8-C14 alkyl polyglucoside surfactant, preferably with an average degree of polymerization of between 0.1 and 3, more preferably between 0.5 and 2.5, even more preferably between 1 and 2. Most preferably the alkyl polyglucoside surfactant has an average alkyl carbon chain length between 10 and 16, preferably between 10 and 14, most preferably between 12 and 14, with an average degree of polymerization of between 0.5 and 2.5 preferably between 1 and 2, most preferably between 1.2 and 1.6. C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Preferably, the composition comprises the anionic surfactant and the non-ionic surfactant in a ratio of from 2:1 to 50:1, preferably 2:1 to 10:1. Preferably the non-ionic surfactant is present from about 0.01 wt % to about 20 wt %, preferably from about 0.2 wt % to about 15 wt %, more preferably from about 0.5 wt % to about 10 wt % by weight of the total liquid detergent composition.

### Salt:

The liquid detergent composition of the present invention may optionally comprise from about 0.01% to about 3%, preferably from about 0.05% to about 2%, more preferably from about 0.2% to about 1.5%, or most preferably from about 0.5% to about 1%, by weight of the total liquid detergent composition of a salt, preferably a monovalent inorganic salt, a divalent inorganic salt, or a mixture thereof, preferably the divalent inorganic salt is a chloride and/or a sulfate salt of magnesium, calcium or zinc, most preferably a magnesium salt, and preferably the monovalent inorganic salt is sodium chloride. The liquid detergent composition alternatively or further comprises a multivalent metal cation in the amount of from about 0.01 wt % to about 2 wt %, preferably from about 0.1% to about 1%, more preferably from about 0.2% to about 0.8% by weight of the liquid detergent composition, preferably the multivalent metal cation is magnesium, aluminum, copper, calcium or iron, more preferably magnesium, most preferably said multivalent salt is magnesium chloride. Without wishing to be bound by theory, it is believed that use of a multivalent cation helps with the formation of protein/protein, surfactant/surfactant or hybrid protein/surfactant network at the oil water and air water interface that is strengthening the suds.

### Carbohydrates

Preferably the liquid detergent composition of the present invention comprises one or more carbohydrates selected from the group comprising 0-glycan, N-glycan, and mixtures thereof. Suitable carbohydrates include alpha or beta glucan with 1,3 and/or 1.4 and/or 1,6 linkage. Glucans can be modified especially with carboxyl sulfate, glycol ether of amino groups. Glucan can be extracted from dextran. Glucan with structure close to natural glucan such as schizophyllan, scleroglucan or paramylon are particularly preferred. Preferably, the liquid detergent composition comprises from about 0.005% to about 1% of the carbohydrates.

### Hydrotrope

The liquid detergent composition of the present invention may optionally comprise from about 0.1% to about 10%, or preferably from about 0.5% to about 10%, more preferably from about 1% to about 6%, or most preferably from about 0.1% to about 3%, or combinations thereof, by weight of the total liquid detergent composition of a hydrotrope, preferably sodium cumene sulfonate. Other suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903. Preferably the liquid detergent composition of the present invention is isotropic. An isotropic liquid detergent composition is distinguished from oil-in-water emulsions and lamellar phase compositions. Polarized light microscopy can assess whether the liquid detergent composition is isotropic. See e.g., The Aqueous Phase Behaviour of Surfactants, Robert Laughlin, Academic Press, 1994, pp. 538-542. Preferably an isotropic liquid detergent composition is provided. Preferably the liquid detergent composition comprises 1% to 3% by weight of the total liquid detergent composition of a hydrotrope, preferably wherein the hydrotrope is selected from sodium, potassium, and ammonium xylene sulfonate, sodium, potassium and ammonium toluene sulfonate, sodium potassium and ammonium cumene sulfonate, and mixtures thereof.

### Organic Solvent

The liquid detergent composition of the present invention may optionally comprise an organic solvent. Suitable organic solvents include C4-14 ethers and diethers, polyols, glycols, alkoxylated glycols, C6-C16 glycol ethers, alkoxylated aromatic alcohols, aromatic alcohols, aliphatic linear or branched alcohols, alkoxylated aliphatic linear or branched alcohols, alkoxylated C1-C5 alcohols, C8-C14 alkyl and cycloalkyl hydrocarbons and halohydrocarbons, and mixtures thereof. Preferably the organic solvents include alcohols, glycols, and glycol ethers, alternatively alcohols and glycols. The liquid detergent composition comprises from 0% to less than about 50%, preferably from about 0.01% to about 25%, more preferably from about 0.1% to about 10%, or most preferably from about 0.5% to about 5%, by weight of the total liquid detergent composition of an organic solvent, preferably an alcohol, more preferably an ethanol, a polyalkyleneglycol, more preferably polypropyleneglycol, and mixtures thereof.

### Amphiphilic Polymer

The liquid detergent composition of the present invention may further comprise from about 0.01% to about 5%, preferably from about 0.05% to about 2%, more preferably from about 0.07% to about 1% by weight of the total liquid detergent composition of an amphiphilic polymer selected from the groups consisting of amphiphilic alkoxylated polyalkyleneimine and mixtures thereof, preferably an amphiphilic alkoxylated polyalkyleneimine.

Preferably, the amphiphilic alkoxylated polyalkyleneimine is an alkoxylated polyethyleneimine polymer comprising a polyethyleneimine backbone having average molecular weight range from about 100 to about 5,000, preferably from about 400 to about 2,000, more preferably from about 400 to about 1,000 Daltons and the alkoxylated polyethyleneimine polymer further comprising:
(i) one or two alkoxylation modifications per nitrogen atom by a polyalkoxylene chain having an average of about 1 to about 50 alkoxy moieties per modification, wherein the terminal alkoxy moiety of the alkoxylation modification is capped with hydrogen, a C1-C4 alkyl or mixtures thereof;
(ii) an addition of one C1-C4 alkyl moiety and one or two alkoxylation modifications per nitrogen atom by a polyalkoxylene chain having an average of about 1 to about 50 alkoxy moieties per modification wherein the terminal alkoxy moiety is capped with hydrogen, a C1-C4 alkyl or mixtures thereof; or
(iii) a combination thereof; and
   wherein the alkoxy moieties comprises ethoxy (EO) and/or propxy (PO) and/or butoxy (BO) and wherein when the alkoxylation modification comprises EO it also comprises PO or BO.

These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like, as described in more detail in PCT Publication No. WO 2007/135645.

### EO-PO-EO Tri-Block Co-Polymer

The liquid detergent composition of the present invention preferably comprises an EO-PO-EO tri-block co-polymer defined according to Formula (I): (EO)x(PO)y(EO)x, wherein EO represents ethylene oxide, and each x represents the number of EO units within the EO block. Each x is independently on average between 1 and 80, preferably between 3 and 60, more preferably between 5 and 50, most preferably between 5 and 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y is on average between 1 and 60, preferably between 10 and 55, more preferably between 10 and 50, more preferably between 15 and 48. The tri-block co-polymers according to the invention are preferably present in the liquid detergent composition at a level of from about 0.1 wt % to about 10 wt %, preferably from about 0.5 wt % to about 7.5 wt %, more preferably from about 1 wt % to about 5 wt %, by weight of the total liquid detergent composition.

### Chelant

The liquid detergent composition herein can comprise a chelant at a level of from about 0.1% to about 20%, preferably from about 0.2% to about 5%, more preferably from about 0.2% to about 3% by weight of total liquid detergent composition.

As commonly understood in the detergent field, chelation herein means the binding or complexation of a bi- or multidentate ligand. These ligands, which are often organic compounds, are called chelants, chelators, chelating agents, and/or sequestering agent. Chelating agents form multiple bonds with a single metal ion. Chelants, are chemicals that form soluble, complex molecules with certain metal ions, inactivating the ions so that they cannot normally react with other elements or ions to produce precipitates or scale, or forming encrustations on soils turning them harder to be removed. The ligand forms a chelate complex with the substrate. The term is reserved for complexes in which the metal ion is bound to two or more atoms of the chelant.

Preferably, the liquid detergent composition of the present invention comprises one or more chelant, preferably selected from the group comprising carboxylate chelants, amino carboxylate chelants, amino phosphonate chelants such as MGDA (methylglycine-N,N-diacetic acid), GLDA (glutamic-N,N-diacetic acid), and mixtures thereof.

Suitable chelating agents can be selected from the group consisting of amino carboxylates, amino phosphonates, polycarboxylate chelating agents and mixtures thereof.

Other chelants include homopolymers and copolymers of polycarboxylic acids and their partially or completely neutralized salts, monomeric polycarboxylic acids and hydroxycarboxylic acids and their salts. Suitable polycarboxylic acids are acyclic, alicyclic, heterocyclic and aromatic carboxylic acids, in which case they contain at least two carboxyl groups which are in each case separated from one another by, preferably, no more than two carbon atoms. A suitable hydroxycarboxylic acid is, for example, citric acid. Another suitable polycarboxylic acid is the homopolymer of acrylic acid. Preferred are the polycarboxylates end capped with sulfonates.

### Adjunct Ingredients

The liquid detergent composition herein may optionally comprise a number of other adjunct ingredients such as builders (e.g., preferably citrate), cleaning solvents, cleaning amines, conditioning polymers, cleaning polymers, surface modifying polymers, soil flocculating polymers, structurants, emollients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g., carboxylic acids such as citric acid, HCl, NaOH, KOH, alkanolamines, phosphoric and sulfonic acids, carbonates such as sodium carbonates, bicarbonates, sesquicarbonates, borates, silicates, phosphates, imidazole and alike).

### Method of Washing

In another aspect, the invention is directed to a method of manually washing dishware comprising the steps of delivering a liquid detergent composition of the invention into a volume of water to form a wash solution and immersing the dishware in the solution. As such, the liquid detergent composition herein will be applied in its diluted form to the dishware. Soiled surfaces e.g. dishes are contacted with an effective amount, typically from about 0.5 mL to about 20 mL (per 25 dishes being treated), preferably from about 3 mL to about 10 mL, of the liquid detergent composition of the present invention diluted in water. The actual amount of the liquid detergent composition used will be based on the judgment of user, and will typically depend upon factors such as the particular product formulation of the liquid detergent composition, including the concentration of active ingredients in the liquid detergent composition, the number of soiled dishes to be cleaned, the degree of soiling on the dishes, and the like. Generally, from about 0.01 mL to about 150 mL, preferably from about 3 mL to about 40 mL of a liquid detergent composition of the invention is combined with from about 2,000 mL to about 20,000 mL, more typically from about 5,000 mL to about 15,000 mL of water in a sink having a volumetric capacity in the range of from about 1,000 mL to about 20,000 mL, more typically from about 5,000 mL to about 15,000 mL. The soiled dishes are immersed in the sink containing the diluted liquid detergent compositions then obtained, where contacting the soiled surface of the dish with a cloth, sponge, or similar article cleans them. The cloth, sponge, or similar article may be immersed in the liquid detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the surface is preferably accompanied by a concurrent scrubbing of the surface.

In another aspect, the invention is directed to a method of manually washing dishware with the liquid detergent composition of the present invention. The method comprises the steps of: i) delivering a liquid detergent composition of the present invention onto the dishware or a cleaning implement; ii) cleaning the dishware with the liquid detergent composition in the presence of water; and iii) optionally, rinsing the dishware. The delivering step is preferably either directly onto the dishware surface or onto a cleaning implement, i.e., in a neat form. The cleaning device or implement is preferably wet before or after the liquid detergent composition is delivered to it. Especially good grease removal has been found when the liquid detergent composition is used in neat form.

In another aspect, the invention is directed to a method of manually washing soiled articles preferably dishware comprising contacting a liquid detergent composition of the invention with a surface preferably dishware, and wherein the liquid detergent composition modifies the hydrophobicity of the surface preferably dishware as a result of the contacting step.

Another aspect of the present invention is directed to a method of promoting suds longevity or grease emulsification in a washing process for washing soiled articles, preferably dishware. The method comprises the steps of: a) delivering a liquid detergent composition of the invention to a volume of water to form a wash liquor; and b) immersing the soiled articles into said wash liquor. Preferably, the potato derived protein or blend of potato derived proteins according to the invention is present at a concentration of about 0.005 ppm to about 60 ppm, preferably at a concentration of about 0.02 ppm to about 12 ppm, based on active protein, in an aqueous wash liquor during the washing process.

The liquid hand dishwashing detergent composition, in particular, comprising the combination of: i) the potato-derived protein selected from patatin, the protease inhibitor, the phosphorylase, and the lipoxygenase and ii) the surfactant system comprising an anionic surfactant and a primary co-surfactant selected from the group consisting of amine oxide surfactant, a betaine surfactant, and mixtures thereof, can be used to provide enhanced suds boosting and/or increased suds longevity in an aqueous wash liquor during a hand dish washing process. Preferably the primary co-surfactant is amine oxide. The weight ratio of anionic surfactant to the primary co-surfactant can be less than about 9:1, more preferably from about 5:1 to about 1:1, more preferably from about 4:1 to about 2:1; to provide enhanced suds boosting and/or increased suds longevity in an aqueous wash liquor during a hand dish washing process.

### Test Methods

The following assays set forth must be used in order that the invention described and claimed herein may be more fully understood.

### Test Method 1—Glass Vial Suds Mileage Method

The objective of the glass vial suds mileage test method is to measure the evolution of suds volume over time generated by a certain solution of detergent composition in the presence of a greasy soil, e.g., olive oil. The steps of the method are as follows:
1. Test solutions are prepared by subsequently adding aliquots at room temperature of: a) 10 g of an aqueous detergent solution at specified detergent concentration and water hardness, b) 1.0 g of an aqueous protein solution at specified concentration and water hardness, and c) 0.11 g of olive oil (Bertolli®, Extra Virgin Olive Oil), into a 40 mL glass vial (dimensions: 95 mm H×27.5 mm D). For the reference samples, the protein solutions are substituted with 1.0 mL of demineralized water. For nil detergent samples the detergent solutions are substituted by water at specified water hardness.
2. The test solutions are mixed in the closed test vials by stirring at room temperature for 2 minutes on a magnetic stirring plate (IKA, model # RTC B 5001; VWR magnetic stirrer, catalog #58949-012; 500 RPM), followed by manually shaking for 20 seconds with an upwards downwards movement (about 2 up and down cycles per second, +/−30 cm up and 30 cm down).
3. Following the shaking, the test solutions in the closed vials are further stirred on a magnetic stirring plate (IKA, model # RTC B 5001; VWR magnetic stirrer, catalog #58949-012; 500 RPM) for 60 minutes inside a water bath at 46° C. to maintain a constant temperature. The samples are then shaken manually for another 20 seconds as described above and the initial suds heights (H1) are recorded with a ruler.
4. The samples are incubated for an additional 30 minutes inside the water bath at 46° C. while stirring (IKA, model # RTC B 5001; VWR magnetic stirrer, catalog #58949-012; 500 RPM), followed by manual shaking for another 20 seconds as described above. The final suds heights (H2) are recorded.
5. Protein solutions that produce larger suds heights (H1 and H2), preferably combined with lower drops in suds height between H1 and H2, are more desirable.

### Test Method 2—Sink Suds Mileage Method

The evolution of the suds volume generated by a solution of a detergent composition can be determined while adding soil loads periodically as follows. A stream of hard water (15 dH) fills a sink (cylinder dimensions: 300 mm D×288 mm H) to 4 L with a constant pressure of 4 bar. Simultaneously, an aliquot of the detergent composition (final concentration 0.12 w %) is dispensed through a pipette with a flow rate of 0.67 mL/sec at a height of 37 cm above the bottom of the sink surface. An initial suds volume is generated in the sink due to the pressure of the water. The temperature of the solution is maintained at 46° C. during the test.

After recording the initial suds volume (average suds height×sink surface area), a fixed amount of greasy soil (composition: see Table 1, 6 mL) is injected in the middle of the sink, while a paddle (dimensions: 10 cm×5 cm, positioned in the middle of the sink at the air liquid interface at an angle of 45 degrees) rotates 20 times into the solution at 85 RPM. This step is followed immediately by another measurement of the total suds volume. The soil injecting, paddling, and measuring steps are repeated until the measured suds volume reaches a minimum level, which is set at 400 cm³. The amount of soil additions needed to get to that level is recorded. The complete process is repeated a number of times and the average of the number of additions for all the replicates is calculated for each detergent composition

Finally, the suds mileage index is then calculated as: (average number of soil additions for test detergent composition)/(average number of soil additions for reference detergent composition)×100.

Pending on the test purpose the skilled person could choose to select an alternative water hardness, solution temperature, product concentration or soil type.

TABLE 1
Greasy Soil Composition

| Ingredient | Weight % |
|---|---|
| Crisco oil | 12.730 |
| Crisco shortening | 27.752 |
| Lard | 7.638 |
| Refined Rendered Edible Beef Tallow | 51.684 |
| Oleic Acid, 90% (Techn) | 0.139 |
| Palmitic Acid, 99+% | 0.036 |
| Stearic Acid, 99+% | 0.021 |

### Examples

The following examples are provided to further illustrate the present invention and are not to be construed as limitations of the present invention, as many variations of the present invention are possible without departing from its spirit or scope.

### Example 1a—Separation of Protein and Preparation of Specific Protein Blends

Sliced potatoes are homogenized in a blend mixer in a 0.1M sodium metabisulfite solution and then partially clarified by Whatman® paper (Grade 0858 1/2, grained—From Aldrich) filtration. The supernatent are collected and centrifuged at 10,000 RPM for 20 mins to further clarify the liquid. Further clarification is achieved by a 2 filtration process through a Whatman® membrane filter mixed cellulose ester (pore size 0.6 μm) from Aldrich. The liquid is freeze-dried after the addition of 1% glucose and resuspended in 0.05 M Tris-glycine buffer at pH 8 to yield a 1-5% protein solution. The protein solution is processed through a filtration membrane also using 0.05 M Tris-glycine buffer at pH 8 media to recuperate either: i) the protease inhibitor (filtrates, through a Vivaspin® 2, Polyethersulfone membrane with 30 kDa MWCO from Aldrich); ii) the patatin (filtrates through 2 membranes, e.g.: retentate from Vivaspin® 2, Polyethersulfone membrane with 30 kDa MWCO and filtrate from 50 kDa MWCO from Aldrich); or iii) a blend of lipoxygenase/phosphorylase (retentate through Vivaspin® 2, Polyethersulfone membrane with 50 kDa MWCO from Aldrich). Therefore, re-blended protein fractions can be conveniently achieved. Alternatively, proteins isolate from Roquettes, Avebe, AKV, KMC, Emsland, etc. can be used as processed material directly for membrane filtration as described herein above.

### Example 1b—Potato Protein Detergent Compositions

The evolution of suds volume generated by a certain solution of detergent composition in presence of a soil, i.e., olive oil or greasy soil, is followed over time under specific conditions (e.g., water hardness, solution temperature, detergent concentrations, etc.). The following solutions are prepared:
A. Hard water (15 dH): 0.75 g MgCl₂.6H₂O (Sigma-Aldrich, catalog # M9272), 2.10 g CaCl₂.6H₂O (Sigma-Aldrich, catalog #21108), and 0.689 g NaHCO₃(Sigma-Aldrich, catalog #31437) are dissolved in 5 L of demineralized water.
B. Detergent solution of a high surfactant content detergent composition (“solution DG-HS”) is prepared using Fairy Dark Green, as commercially available in the UK in February 2017, diluted in hard water (15 dH) prepared as above, at targeted detergent concentration of 0.12%.
C. Protein solutions: Proteins are diluted in demineralized water to the required concentration before proceeding with the suds mileage method.
D. Greasy soil: A grease soil is prepared according to the composition described in Table 1.

### Example 2—Sink Suds Mileage of Detergent Compositions Comprising Potato Derived Protein with Greasy Soil

Inventive Composition A is an example of a detergent composition according to the present invention, made with: a) detergent solution DG-HS (prepared as described in Example 1b) comprising a surfactant system according to the invention, and b) a diluted sample of potato protein (obtained as described in Example 1a) according to the invention. Comparative Composition B contains the same detergent solution DG-HS comprising the surfactant system according to the invention but in the absence of the potato protein according to the invention. The sink suds mileage test is performed on these compositions using greasy soil ex Table 1, as described in the test methods section (Test Method 2). The suds mileage index, as described in the test method 2 section above is recorded in Table 2.

TABLE 2
Suds Mileage (with 2% greasy soil—(0.12% detergent
concentration/46° C./15 dh—1% protein in finished products)

| | Suds Mileage Index |
|---|---|
| Comparative Composition B | 100.0 |
| Inventive Composition A | 113 |
| (with Tubermine ® FV) | |

The results confirm that Inventive Composition A detergent solution comprising a potato protein and a surfactant system according to the invention has a superior suds profile compared to Comparative Composition B solution comprising the surfactant system according to the invention but without the protein according to the invention, under sink testing conditions. Inventive Composition A was also tested in the absence of detergent solution DG-HS, hence solely comprising the protein according to the invention, with the glass vial test method with olive oil and did not show any suds formation (data not shown), illustrating a suds mileage synergy between the surfactant system and the protein according to the invention accordingly.

### Example 5: Exemplary Manual Dish-Washing Detergent Composition

TABLE 5
exemplifies manual dish-washing detergent compositions comprising
Tubermine ® FV potato derived protein.

| | 5A | 5B | 5C |
|---|---|---|---|
| Ingredient | Wt % | Wt % | Wt % |
| Sodium alkyl ethoxy sulfate | 22.91% | 21% | 9% |
| (C1213EO0.6S) | | | |
| HLAS | — | — | 9% |
| n-C12-14 Di Methyl Amine Oxide | 7.64% | — | 3% |
| Coco-amidopropylbetaine | — | 7% | 3% |
| Lutensol ® XP80 (non-ionic | 0.45% | — | — |
| surfactant supplied by BASF) | | | |
| Sodium Chloride | 1.2% | 1% | 1.3% |
| Poly Propylene Glycol (MW 2000) | 1% | 0.8% | 0.7% |
| Ethanol | 2% | 1.5% | 1% |
| Tubermine ® FV (available | 1% | 0.75% | 0.8% |
| from Roquette, France)* | | | |
| Minors (perfume, preservative, | To 100 % | To 100% | To 100% |
| dye) + water | | | |
| pH (@ 10% solution—through | 9 | 8.5 | 9 |
| NaOH trimming) | | | |

*Tubermine ® FV is a commercially available potato protein (minimum 77% protein content). Add-on % is based on total raw material added.

All percentages and ratios given for proteins are based on active protein, unless otherwise specified. All percentages and ratios herein are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. A liquid detergent composition comprising:
a) from about 1 wt % to about 60 wt % by weight of the liquid detergent composition of a surfactant system, wherein the surfactant system comprises:
i) an anionic surfactant; and
ii) a primary co-surfactant selected from the group consisting of an amine oxide surfactant, a betaine surfactant, and mixtures thereof; and
b) from about 0.005 wt % to about 10 wt % by weight of the liquid detergent composition of a potato-derived protein, wherein the potato-derived protein comprises, based on active protein:
i) from about 10 wt % to about 80 wt % by weight of the total potato-derived protein of a protein belonging to the patatin family;
ii) from about 10 wt % to about 75 wt % by weight of the total potato-derived protein of a protein belonging to the protease inhibitor family; and
iii) from about 10 wt % to about 75 wt % by weight of the total potato-derived protein of a protein belonging to the lipoxygenase family; and
iv) below about 15% by weight of the total potato-derived protein of a protein belonging to the phosphorylase family.

2. The liquid detergent composition according to claim 1 wherein the composition comprises from 5 wt % to 50 wt % by weight of the liquid detergent composition of the surfactant system.

3. The liquid detergent composition according to claim 2 wherein the composition comprises from about 15 wt % to about 40 wt %, by weight of the liquid detergent composition of the surfactant system.

4. The liquid detergent composition according to claim 1 wherein the anionic surfactant is selected from the group consisting of sulfate surfactants, sulfonate surfactants, and mixtures thereof.

5. The liquid detergent composition according to claim 4 wherein the anionic surfactant is a sulfate surfactant selected from the group consisting of: alkyl sulfate, alkyl alkoxy sulfate, and mixtures thereof.

6. The liquid detergent composition according to claim 1 wherein the composition comprises from about 0.5 wt % to about 5 wt %, by weight of the liquid detergent composition of the potato-derived protein.

7. The liquid detergent composition according to claim 1 wherein the patatin has at least about 80% amino acid identity as calculated over the entire length of the sequence aligned against the entire length of a Patatin protein (SEQ ID NOs: 1-10).

8. The liquid detergent composition according to claim 7 wherein the patatin has at least about 90% amino acid identity as calculated over the entire length of the sequence aligned against the entire length of a Patatin protein (SEQ ID NOs: 1-10).

9. The liquid detergent composition according to claim 1 wherein the protease inhibitor has at least about 80% amino acid identity as calculated over the entire length of the sequence aligned against the entire length of a Protease Inhibitor protein (SEQ ID NOs: 11-22).

10. The liquid detergent composition according to claim 9 wherein the protease inhibitor has at least about 90% amino acid identity as calculated over the entire length of the sequence aligned against the entire length of a Protease Inhibitor protein (SEQ ID NOs: 11-22).

11. The liquid detergent composition according to claim 1 wherein the phosphorylase has at least about 80% amino acid identity as calculated over the entire length of the sequence aligned against the entire length of a Phosphorylase protein (SEQ ID NOs: 23-28).

12. The liquid detergent composition according to claim 11 wherein the phosphorylase has at least about 90% amino acid identity as calculated over the entire length of the sequence aligned against the entire length of a Phosphorylase protein (SEQ ID NOs: 23-28).

13. The liquid detergent composition according to claim 1 wherein the lipoxygenase has at least about 80% amino acid identity as calculated over the entire length of the sequence aligned against the entire length of a Lipoxygenase protein (SEQ ID NOs: 29-38).

14. The liquid detergent composition according to claim 13 wherein the lipoxygenase has at least about 90% amino acid identity as calculated over the entire length of the sequence aligned against the entire length of a Lipoxygenase protein (SEQ ID NOs: 29-38).

15. The liquid detergent composition according to claim 1 wherein:
b) the total potato-derived protein comprises, based on active protein:
i) from about 30 wt % to about 60 wt %, by weight of the total potato-derived protein of a protein belonging to the patatin family;
ii) from about 30 wt % to about 50 wt %, by weight of the total potato-derived protein of a protein belonging to the protease inhibitor family; and
iii) about 30 wt % to about 50 wt %, by weight of the total potato-derived protein of a protein belonging to the lipoxygenase family; and
iv) below about 5%, by weight of the total potato-derived protein of a protein belonging to the phosphorylase family;
wherein the sum total weight percentage of i), ii), iii) and iv) equals about 100 wt % by weight of the total potato-derived protein.

16. The liquid detergent composition according to claim 1, wherein the patatin has a phospholipase activity.

17. The liquid detergent composition according to claim 1, wherein the lipoxygenase has an unsaturated fatty acid transforming activity.

18. The liquid detergent composition according claim 1 wherein:
a) the surfactant system comprises:
i) an anionic surfactant which is an alkyl ethoxy sulfate, wherein the alkyl ethoxy sulfate has an average degree of ethoxylation of less than about 2 and more than about 0.5; and
ii) the primary co-surfactant is an amine oxide selected from the group consisting of linear or branched alkyl amine oxide, linear or branched alkyl amidopropyl amine oxide, and mixtures thereof.

19. The liquid detergent composition according to claim 1 wherein the composition further comprises from about 1.5 wt % to about 5 wt %, by weight of the surfactant system of a non-ionic surfactant.

20. A method of manually washing dishware comprising the steps of delivering the liquid detergent composition according to claim 1 to a volume of water to form a wash liquor and immersing the dishware in the wash liquor or delivering the liquid detergent composition according to claim 1 directly onto the dishware or cleaning implement and using the cleaning implement to clean the dishware.


SEQUENCE LISTING (38 sequences)

SEQ ID NO: 1 - protein, 386 aa, Unknown
  Potato
MATTKSFLILFFMILATTSSTCATLGEMVTVLSIDGGGIKGIIPAIILEFLEGQLQEVDNNKDARLADYFDVIGGTSTGGLLTAMITTPNENNRPFAAAKDIVPFYFEHGPHIFNYSGSIFGPRYDGKYLLQVLQEKLGETRVHQALTEVAISSFDIKTNKPVIFTKSNLAESPQLDAKMYDICYSTAAAPIYFPPHHFVTHTSNGATYEFNLVDGAVATVGDPALLSLSVATRLAQDDPAFSSIKSLDYKQMLLLSLGTGTNSEFDKTYTAEEAAKWGPLRWMLAIQQMTNAASSYMTDYYISTVFQARHSQNNYLRVQENALTGTTTEMDDASEANMELLVQVGETLLKKPVSKDSPETYEEALKRFAKLLSDRKKLRANKASH

SEQ ID NO: 2 - protein, 466 aa, Unknown
  Potato
MESNVISDMRLEPSIDTDKLSYEIFSILESKFLFGYDDQKLWVPKNLPSPVEDNKNDGVLTTSATENIQAIKNQRGKICILSIDGGGMRNILSGKALAYLEQALKVKSGNPEARIADYFDVAVGSGVGGIFTAMLFSTKDQNRPVFQAEDTWKLLEEQGRRIYPSKGSSSAGNGFLRRVFRGGATRSDTSGLEKVMKEAFMDKKTGRSLTLKDTLKPVLIPCYDLSSTAPFLFSRADAFESESFDFRLWEVCRATSAEPGLFEPVCMKSVDGKTGCVAVDGGLAMSNPTAAAITHVLHNKQEFPFVRGVEDILVLSLGTGQLLEGSFQYEHVKKWKAKDWAKPMARISGDGAADMVDHSVAMAFGQCRSSNYVRIQANGSSFGRCGVNIDADPSPNNVKKLVGIADEMLKQKNVESLLFGGRKIAEQSNFQKLDWFAGELVQEHQRRSCRIAPTVAFKQHLTNQEK

SEQ ID NO: 3 - protein, 420 aa, Unknown
  Potato
MGKIFVAALTLLVTLQVLHIPIAFAATTGKKLTILSIDGGGIRGIIPGTLLAFLESKLQELDGPNARIADYFDVVAGTSTGGLIATMLTAPNKDNRPLYAAKNITNFYMDHGPKIFPESSRSSFLKRLTNLFGGPKYDGKYLKTLVRSILGNLTVTQTLTQLVVPSFDIKRLQAVVFTTSDAKAHVSKDALLSDVCLGTSAAPTYFPVHYFETKDSQGKTRTFDLVDGGVAANNPTLVAITQTSKEIMLGKLRNANLKPMDCKKMLVLSLGTGIAKDEKKYSAAAASTWGVLGWLYSNGASPLLDVYGDASADIVDVHLSTIFQSLESEKNYLRIQDDSLSGEASSMDVATRKNMEALVQIGNDRLKKAVSRVNLDTGRYEEVSGEGTNEEALIRFAKLLSEQRKIRQPLDEFSSTRKIL

SEQ ID NO: 4 - protein, 382 aa, Unknown
  Potato
MELDKVTMEIFSKLEQKWLYQYEQKKTRILTIDGGGTTGIVCGAGLIHLEDQICSKTGDPHARVSDYFDIIAGTGIGAVFAAMLVADGGDGRPIFTAKDAVKFVTVNQTRLFKAKNVGVFPRKRRYSGKSMDKVLKEAFIREDGKVMTLRDTCKPILVPCFDLNSSAPFVFSRADATESTSFDFELWKVCRATSANPSMFKPFQLNSVDGKTSCSAVDGGLVMNNPAAAAVTHVLHNKRDFPSVTSVDDLLVLSLGNGPLSPQSNMKLRNDGYCSPSSVVGIVVDGVSETADQILGNAFCWNPNDYVRIQANGYTSGRVGPRPKEEEVLEERVIESLPFGGKRLLTETNRQRIGSFVQRLVKSSLPPSPCKETNVNPLVNGR

SEQ ID NO: 5 - protein, 379 aa, Unknown
  Potato
MDFSKISLEIFSKLEQKWLYHYEGKKTRVLSIDGGGTTGIVAGAALIHLENQICAKTGDPHVRISDFFDIVVGTGIGAIYAAMLVVDGGDGRPLFTAKDAVKFVKENQSRLFKAKKVGVLRRKKRFSGKSMEKVLKEVFRREDGKALTLRDTCKPLLVPCFDLNSSAPFVFSRADAIESFSYDFDLWKVCRATSANPSMFKPFNLESIDGKTSCLAVDGGLVMNNPAAAAVTHVLHNKRDFPAVTGVDDLLVLSLGNGPLNSTTNLKMRNDGYCSPLSVVGIVFDGVSETVDQMLGNAFCWNPNDYVRVQATGYASGGVEEALEERGVESLPFGGKRLLTETNGQRIGGLVQRLVATGRSSVPPSPCKDVAVSPLRNGR

SEQ ID NO: 6 - protein, 429 aa, Unknown
  Potato
MAAAAISTISMIDSNMEVDKLTYEIFSILENKFLFGYDNDPKLSSACVDNLNFSTPKKNVPAGKIRILSIDGGGSTNGILAAKSLTHLETTLRRITGKKNTHIADFFDVVAGSGTGGILATLLFTRGKDGVPLFTAEEALKFLIENNRKISRSSSNGVLQRVFRPPVKVFGKVFGDLTLKETVKAVLIPCYDLTTRSPFLFSRADALEMDGCDFKLSDVCGATIADRTVEVKSVDGRRKITAVGGGVTMNNPTAAAITHVLNNKQEFPFANSVEDLLVISLGNGESDSGTGNMTSSPAAFVKIAGDGAADMVDQAVSMAFGEFRNNNYVRVQGNEIIGKKQHMIKDEKMRKSIVIAEEMLKQKNVESILFQGKKLVEKTNLDKLEIFAGELIKEEEMRKNSILSPVVLKQSPSSPRTSSATTLSTISSC

SEQ ID NO: 7 - protein, 412 aa, Unknown
  Potato
MGRMVLIAAAMTLFVTLQVLQAPLMVSAATKGKTVTILSIDGGGIRGVIPGTLLAFLESKLQELDGPNARLADYFDVVAGTSTGGLVTTMLTAPNKDNRPLYQAKDISNFYMEHGPQIFPQSRRNSFVRRVTNLFGGPKYDGIYLRTIINSILGNITMKQTLTNTVIPTFDIKRLQPIIFSTADAKANISKNAQLSDVCLSTSAAPTYFPVHSFETKDAQGKPRTFDLVDGGVAANNPTLMAITYVSKQIMTGNFQYEGMKNMDCKKMLVLSLGTGIGKQEEKYNATVASRWGMLGWVYNNGATPLIDIYGDASADMVDIHVSTMFQTLGSEKNYIRIQDDNLTGEAASMDIATTKNMETLVQIGNDLLKKPISRVNLETGRYEPVVGEGTNEAAIVRFAQLLSEERKLRIN

SEQ ID NO: 8 - protein, 382 aa, Unknown; identical to SEQ ID NO: 4
  Potato

SEQ ID NO: 9 - protein, 379 aa, Unknown; identical to SEQ ID NO: 5
  Potato

SEQ ID NO: 10 - protein, 429 aa, Unknown; identical to SEQ ID NO: 6
  Potato

SEQ ID NO: 11 - protein, 222 aa, Unknown
  Potato
MKSINILSFLLLSSTLSLVAFARSFTSENPIVLPTTCHDDDNLVLPEVYDQDGNPLRIGERYIINNPLLGAGAVYLYNIGNLQCPNAVLQHMSIPQFLGEGTPVVFVRKSESDYGDVVRVMTVVYIKFFVKTTKLCVDQTVWKVNDEQLVVTGGKVGNENDIFKIMKTDLVTPGGSKYVYKLLHCPSHLGCKNIGGNFKNGYPRLVTVDDDKDFIPFVFIKA

SEQ ID NO: 12 - protein, 221 aa, Unknown
  Potato
MMKCLFFLCLCLFPILVFSSTFTSQNPINLPSESPVPKPVLDTNGKKLNPNSSYRIISTFWGALGGDVYLGKSPNSDAPCPDGVFRYNSDVGPSGTPVRFIPLSTNIFEDQLLNIQFNIPTVKLCVSYTIWKVGNLNTHLWTMLLETGGTIGKADSSYFKIVKSSKFGYNLLYCPITRPPIVCPFCRDDDFCAKVGVVIQNGKRRLALVNENPLDVLFQEV

SEQ ID NO: 13 - protein, 221 aa, Unknown
  Potato
IPSINILSFLLLSSTLSLVAFARSFTSENPIVLPTTCHDDDNLVLPEVYDQDGNPLRIGERYIIKNPLLGAGAVYLDNIGNLQCPNAVLQHMSIPQFLGKGTPVVFIRKSESDYGDVVRLMTAVYIKFFVKTTKLCVDETVWKVNNEQLVVTGGNVGNENDIFKIKKTDLVIRGMKNVYKLLHCPSHLECKNIGSTFKNGYPRLVTVNDEKDFIPFVFIKA

SEQ ID NO: 14 - protein, 221 aa, Unknown; identical to SEQ ID NO: 13
  Potato

SEQ ID NO: 15 - protein, 220 aa, Unknown
  Potato
MMKCLFLLCLCLLPIVVFSSTFTSQNLIDLPSESPLPKPVLDTNGKELNPNSSYRIISIGRGALGGDVYLGKSPNSDAPCPDGVFRYNSDVGRSGTPVRFIPLSTNIFENQLLNIQFNIPTVKLCVSYTIWKVGNLNAHLRTMLLETGGTIGQADSSYFKIVKSSKFGYNLLYCPITPPFLCPFCRDDNFCAKVGVVIQNGKRRLALVNENPLDVLFQEV

SEQ ID NO: 16 - protein, 220 aa, Unknown; identical to SEQ ID NO: 15
  Potato

SEQ ID NO: 17 - protein, 186 aa, Unknown
  Potato
TCHDDDNLVLPEVYDQDGNPLRIGERYIIKNPLLGAGAVYLDNIGNLQCPNAVLQHMSIPQFLGKGTPVVFIRKSESDYGDVVRLMTAVYIKFFVKTTKLCVDETVWKVNNEQLVVTGGNVGNENDIFKIKKTDLVIRGMKNVYKLLHCPSHLECKNIGSNFKNGYPRLVTVNDEKDFIPFVFIKA

SEQ ID NO: 18 - protein, 186 aa, Unknown
  Potato
LPSDATPVLDVTGKELDSRLSYRIISTFWGALGGDVYLGKSPNSDAPCANGIFRYNSDVGPSGTPVRFIGSSSHFGQGIFENELLNIQFAISTSKLCVSYTIWKVGDYDASLGTMLLETGGTIGQADSSWFKIVKSSQLGYNLLYCPVTSSSDDQFCSKVGVVHQNGKRRLALVNENPLDVLFQEV

SEQ ID NO: 19 - protein, 169 aa, Unknown
  Potato
NSSYRIISIGRGALGGDVYLGKSPNSDAPCPDGVFRYNSDVGPSGTPVRFIPLSGGIFEDQLLNIQFNIPTVKLCVSYTIWKVGNLNAYFRTMLLETGGTIGQADNSYFKIVKSSKIGYNLLSCPFTSIICLRCPEDQFCAKVGVVIQNGKRRLALVNENPLDVLFQEV

SEQ ID NO: 20 - protein, 151 aa, Unknown
  Potato
GAVYLYNIGNLQCPNAVLQHMSIPQFLGEGTPVVFVRKSESDYGDVVRVMTVVYIKFFVKTTKLCVDQTVWKVNDEQLVVTGGKVGNENDIFKIMKTDLVTPGGSKYVYKLLHCPSHLGCKNIAGNFKNGYPRLVTVDDDKDFIPFVFIKA

SEQ ID NO: 21 - protein, 103 aa, Unknown
  Potato
ISTSKLCVSYTIWKVGDYDASLGTMLLETGGTIGQADSSWFKIVQSSQFGYNLLYCPVTSTMSCPFSLDDQFCLKVGVVHQNGKRRLALVNGNPLECLFKQVQ

SEQ ID NO: 22 - protein, 42 aa, Unknown
  Potato
  misc_feature (30)..(30): Xaa can be any naturally occurring amino acid
  misc_feature (35)..(35): Xaa can be any naturally occurring amino acid
LPSDATPVLDVTGKELDPRLSYRIISIGRXALGGXVYLGKSP

SEQ ID NO: 23 - protein, 838 aa, Unknown
  Potato
MEGGAKSNDVSAAPIAQPLSEDPTDIASNIKYHAQYTPHFSPFKFEPLQAYYAATADSVRDRLIKQWNDTYLHYDKVNPKQTYYLSMEYLQGRALTNAVGNLDIHNAYADALNKLGQQLEEVVEQEKDAALGNGGLGRLASCFLDSMATLNLPAWGYGLRYRYGLFKQLITKAGQEEVPEDWLEKFSPWEIVRHDVVFPIRFFGHVEVLPSGSRKWVGGEVLQALAYDVPIPGYRTKNTNSLRLWEAKASSEDFNLFLFNDGQYDAAAQLHSRAQQICAVLYPGDATENGKLLRLKQQFFLCSASLQDIIARFKEREDGKGSHQWSEFPKKVAIQLNDTHPTLTIPELMRLLMDDEGLGWDESWNITTRTIAYTNHTVLPEALEKWSQAVMWKLLPRHMEIIEEIDKRFVATIMSERPDLENKMPSMRILDHNATKPVVHMANLCVVSSHTVNGVAQLHSDILKAELFADYVSVWPTKFQNKTNGITPRRWIRFCSPELSHIITKWLKTDQWVTNLELLANLREFADNSELHAEWESAKMANKQRLAQYILHVTGVSIDPNSLFDIQVKRIHEYKRQLLNILGVIYRYKKLKGMSPEERKNTTPRTVMIGGKAFATYTNAKRIVKLVTDVGDVVNSDPDVNDYLKVVFVPNYNVSVAEMLIPGSELSQHISTAGMEASGTSNMKFALNGCLIIGTLDGANVEIREEIGEDNFFLFGATADEVPQLRKDRENGLFKPDPRFEEAKQFIRSGAFGTYDYNPLLESLEGNSGYGRGDYFLVGHDFPSYMDAQARVDEAYKDRKRWIKMSILSTSGSGKFSSDRTISQYAKEIWNIAECRVP

SEQ ID NO: 24 - protein, 955 aa, Unknown
  Potato
MTAQAPLSVAPFLQTPARPSEAPGALLPFSLTYSRYVQRLAQARAGWAERVQAAAAGPIGVAWLSARFGELFEAAAVEPEQALKRALRLLRNEVFAALAERDLSGAATLDEVTGTMTDFAEFAVRAAISVIGQELGALHGQPVGQSSGEVQELVVVGMGKLGGRELNVSSDIDLIFLYDEEGDTQGGPRPLSNHEYFTKLGRRLINALADVTEDGYVFRVDMRLRPNGDAGPLACSLGMLEEYFVVQGREWERYAWIKGRVITDPGSPHAARVIQQLERVTTPFVFRRYLDYGVIAAIRALHAQIRAEAAKRSNSANRQHGGHHGHVQARSPNIKLGRGGIREIEFVAQVFQLIRGGQDFALRIRPTLEVLRTAAERGLIGADAIARLTDAYRFLRQLEHRLQYVDDAQTHNLPGAPEDQLRIARMMGFADYAALVAQLERHQDEVAQHFEQTFSDKQDNQPPCAAIWHADLLDDERTESARAQLLELGYADADSVLERLRASRHSPRYRALSEVSRQRFDLLINRALDHAAQQTDADVTIARFLDFFDAISRRASYLSLLCEYPQAMARVAHTLHASRWAADYLTRHPQLLDELLDTDALSAAPDWQAFRERVRDRLRAAGDHVEMQMDILRQEHHAETFRILLQDLQGMLTVEPISDRLSDLADAVLDLTLETVWQQVSTRHRETPRFAVVAYGRLGGKELGYASDLDLIFLYDDDDERAPEVYAAFARKLITWLTSHTAAGTLFDVDTRLRPNGAAGLMVTHFEAFRRYQMREGDNAAWVWEHQALTRARFCAGDPEIGARFEALRIAVLRQPREARPLRDEIAAMRERVLEGHANPTPLFDLKHDRGGMVDIEFTVQFLVLLHSAAHAELTRNAGNIALLRMAGELGLIDAARAAQVADAYRDFRARQHKLRLDGQSAARVPAGTCAHEVAHVRALWEQVFGSVDAASHAQ

SEQ ID NO: 25 - protein, 966 aa, Unknown
  Potato
MATANGAHLFNHYSSNSRFIHFTSRNTSSKLFLTKTSHFRRPKRCFHVNNTLSEKIHHPITEQGGESDLSSFAPDAASITSSIKYHAEFTPVFSPERFELPKAFFATAQSVRDSLLINWNATYDIYEKLNMKQAYYLSMEFLQGRALLNAIGNLELTGAFAEALKNLGHNLENVASQEPDAALGNGGLGRLASCFLDSLATLNYPAWGYGLRYKYGLFKQRITKDGQEEVAEDWLEIGSPWEVVRNDVSYPIKFYGKVSTGSDGKRYWIGGEDIKAVAYDVPIPGYKTRTTISLRLWSTQVPSADFDLSAFNAGEHTKACEAQANAEKICYILYPGDESEEGKILRLKQQYTLCSASLQDIISRFERRSGDRIKWEEFPEKVAVQMNDTHPTLCIPELMRILIDLKGLNWNEAWNITQRTVAYTNHTVLPEALEKWSYELMQKLLPRHVEIIEAIDEELVHEIVLKYGSMDLNKLEEKLTTMRILENFDLPSSVAELFIKPEISVDDDTETVEVHDKVEASDKVVTNDEDDTGKKTSVKIEAAAEKDIDKKTPVSPEPAVIPPKKVRMANLCVVGGHAVNGVAEIHSEIVKEEVFNDFYELWPEKFQNKTNGVTPRRWIRFCNPPLSAIITKWTGTEDWVLKTEKLAELQKFADNEDLQNEWREAKRSNKIKVVSFLKEKTGYSVVPDAMFDIQVKRIHEYKRQLLNIFGIVYRYKKMKEMTAAERKTNFVPRVCIFGGKAFATYVQAKRIVKFITDVGATINHDPEIGDLLKVVFVPDYNVSVAELLIPASDLSEHISTAGMEASGTSNMKFAMNGCIQIGTLDGANVEIREEVGEENFFLFGAQAHEIAGLRKERADGKFVPDERFEEVKEFVRSGAFGSYNYDDLIGSLEGNEGFGRADYFLVGKDFPSYIECQEKVDEAYRDQKRWTTMSILNTAGSYKFSSDRTIHEYAKDIWNIEAVEIA

SEQ ID NO: 26 - protein, 974 aa, Unknown
  Potato
MATFAVSGLNSISSISSFNNNFRSKNSNILLSRRRILLFSFRRRRRSFSVSSVASDQKQKTKDSSSDEGFTLDVFQPDSTSVLSSIKYHAEFTPSFSPEKFELPKAYYATAESVRDTLIINWNATYEFYEKMNVKQAYYLSMEFLQGRALLNAIGNLGLTGPYADALTKLGYSLEDVARQEPDAALGNGGLGRLASCFLDSMATLNYPAWGYGLRYQYGLFKQLITKDGQEEVAENWLEMGNPWEIVRNDISYPVKFYGKVIEGADGRKEWAGGEDITAVAYDVPIPGYKTKTTINLRLWTTKLAAEAFDLYAFNNGDHAKAYEAQKKAEKICYVLYPGDESLEGKTLRLKQQYTLCSASLQDIIARFEKRSGNAVNWDQFPEKVAVQMNDTHPTLCIPELLRILMDVKGLSWKQAWEITQRTVAYTNHTVLPEALEKWSFTLLGELLPRHVEIIAMIDEELLHTILAEYGTEDLDLLQEKLNQMRILDNVEIPSSVLELLIKAEESAADVEKAADEEQEEEGKDDSKDEETEAVKAETTNEEEETEVKKVEVEDSQAKIKRIFGPHPNKPQVVHMANLCVVSGHAVNGVAEIHSEIVKDEVFNEFYKLWPEKFQNKTNGVTPRRWLSFCNPELSEIITKWTGSDDWLVNTEKLAELRKFADNEELQSEWRKAKGNNKMKIVSLIKEKTGYVVSPDAMFDVQIKRIHEYKRQLLNIFGIVYRYKKMKEMSPEERKEKFVPRVCIFGGKAFATYVQAKRIVKFITDVGETVNHDPEIGDLLKVVFVPDYNVSVAEVLIPGSELSQHISTAGMEASGTSNMKFSMNGCLLIGTLDGANVEIREEVGEDNFFLFGAQAHEIAGLRKERAEGKFVPDPRFEEVKAFIRTGVFGTYNYEELMGSLEGNEGYGRADYFLVGKDFPDYIECQDKVDEAYRDQKKWTKMSILNTAGSFKFSSDRTIHQYARDIWRIEPVELP

SEQ ID NO: 27 - protein, 975 aa, Unknown
  Potato
MATFAVSGLNSISSISSFNNNFRSKNSNILLSRRRILLFSFRRRRRRSFSVSSVASDQKQKTKDSSSDEGFTLDVFQPDSTSVLSSIKYHAEFMPSFSPEKFELPKAYYATAESVRDTLIINWNATYEFYEKMNVKQAYYLSMEFLQGRALLNAIGNLGLTGPYADALTKLGYSLEDVARQEPDAALGNGGLGRLASCFLDSMATLNYPAWGYGLRYQYGLFKQLITKDGQEEVAENWLEMGNPWEIVRNDISYPVKFYGKVIEGADGRKEWAGGEDITAVAYDVPIPGYKTKTTINLRLWTTKLAAEAFDLHAFNNGDHAKAYEAQKKAEKICYVLYPGDESLEGKTLRLKQQYTLCSASLQDIIARFEKRSGNAVNWDQFPEKVAVQMNDTHPTLCIPELLRILMDVKGLSWKQAWEITQRTVAYTNHTVLPEALEKWSFTLLGELLPRHVEIIAMIDEELLHTILAEYGTEDLDLLQEKLNQMRILDNVEIPTSVLELLIKAEENAADVEKAADEEQEEEGKDDSKDEETEAVKAETTNEEEETEVKKVEVEDSQAKIKRIFGPHPNKSQVVHMANLCVVSGHAVNGVAEIHSEIVKDEVFNEFYKLWPEKFQNKTNGVTPRRWLSFCNPELSEIITKWTGSDDWLVNTEKLAELRKFADNEELQSEWRKAKGNNKMKIVSLIKEKTGYVVSPDAMFDVQIKRIHEYKRQLLNIFGIVYRYKKMKEMSPEERKEKFVPRVCIFGGKAFATYVQAKRIVKFITDVGATVNHDPEIGDLLKVVFVPDYNVSVAEVLIPGSELSQHISTAGMEASGTSNMKFSMNGCLLIGTLDGANVEIREEVGEDNFFLFGAQAHEIAGLRKERAEGRFVPDPRFEEVKVFIRTGVFGTYNYEELMGSLEGNEGYGRADYFLVGKDFPDYIECQDKVDEAYRDQKKWTKMSILNTAGSFKFSSDRTIHQYARDIWRIEPVELP

SEQ ID NO: 28 - protein, 1005 aa, Unknown
  Potato
MAAISVPLLAVRSPPTNLPFPSIFNLNRPFSTSLSSNAFSHLKVSSSTSSSNQAVTETTSTSSSTINVQNDDALDTTLFVIRAKNRIGLLQIITRVFKVLGLKIEKAIIEFEGEFFVKKFYVNDSNGKKIEKMEYLEKIQKALLEAIDGDDGGAGVSAPSAVSGRGVVVRKPGLNMELGGRKAKVEKMFGLMDEFLKNDSISLQKDILDHVEFTVARSRFSFDDFEAYQALAHSVRDRLIERWHDTHQYFKKKDPKRIYFLSLEFLMGRSLTNSVTNLGIQDQYADALTQLGFDYEVLAEQEGDAALGNGGLARFAACQMDSLATLDYPAWGYGLRYQYGLFRQIIVDGFQHEQPDFWLNFGNPWEIERVHVSYPVKFYGTVEEEVLNGKKCKIWIPGESVEAVAYDNPIPGYGTRNAINLRLWAAKPSDQYDMESYTTGDYINAIVNRQKAETISNVLYPDDRSYQGKELRLKQQYFFVSASLQDIMRRFKDLHRSFDEFPEKVALQINDTHPSISIAEVMRVLVDEEHLDWSKAWDIACRIFSVTIHAVQPEGLEKIPVDLLGSVLPRHLEIIYEINYRLMEELKKNFGQDYDKLSRMSIIEEGAVKTIRMANLSLACCHTVNGVSRVHLETLKTRVFKDFYELWPQKFQCKTNGVTQRRWIVVSNPSLCSIISKWLGTEAWIRNVDLIAGLREYAKDPDLHTEWKNMKRVNKMRLAEYIETLTSVKVSLDAMFDVQIKRIHEYKRQLLNMLGIIHRYDCIKNMDESDKRRVVPRVCIIGGKAAPGYEVAKKIIKLCHAVADKVNNDPDVGDLLKVVFIPDYNVSVAELVIPGSDLSQHLSTAGHEASGTGCMKFLMNGCLLLATADGSAVEIAEEIGAENMFLFGAKVDEVPALREKGTTLKGSLQFARVVRMVRDGYFGFKDYFKSLCDTVEDGGDFYLLGYDFASYLEAQAAADRTFVDQEKWIQMSILSTAGSGKFSSDRTIEEYAQQSWGIEPCKCPF

SEQ ID NO: 29 - protein, 899 aa, Unknown
  Potato
MLKPQLQQSSQSTKALIPSWNTNPLFLASFPINILNKNFRLKKKNNFRVHHNYNGASTTKAVLSSTEKATGVKAVVTVQKQVNLNLSRGLDDIGDLLGKSLLLWIVAAELDHKTGIEKPGIRAYAHRGRDVDGDTHYEADFVIPQDFGEVGAILIENEHHKEMYVKNIVIDGFVHGKVEITCNSWVHSKFDNPDKRIFFTNKSYLPSQTPSGVSRLREEELVTLRGDGIGERKVFERIYDYDVYNDLGEADSNNDDAKRPVLGGKELPYPRRCKTGRPRSKKDPLSETRSTFVYVPRDEAFSEVKSVAFSGNTVYSVLHAVVPALESVVTDPNLGFPHFPAIDSLFNVGVDLPGLGDKKSGLFNVVPRLIKAISDTRKDVLLFESPQLVQRDKFSWFRDVEFARQTLAGLNPYSIRLVTEWPLRSKLDPKVYGPPESEITKELIEKEIGNYMTVEQAVQQKKLFILDYHDLLLPYVNKVNELKGSMLYGSRTIFFLTPQGTLKPLAIELTRPPVDDKPQWKEVYSPNDWNATGAWLWKLAKAHVLSHDSGYHQLVSHWLRTHCCTEPYIIASNRQLSAMHPIYRLLHPHFRYTMEINALAREALINANGVIESSFFPGKYAIELSSIAYGAEWRFDQEALPQNLISRGLAVEDPNEPHGLKLAIEDYPFANDGLVLWDILKQWVTNYVNHYYPQTNLIESDKELQAWWSEIKNVGHGDKRDEPWWPELKTPNDLIGIITTIVWVTSGHHAAVNFGQYSYAGYFPNRPTVARSKMPTEDPTAEEWEWFMNKPEEALLRCFPSQIQATKVMAILDVLSNHSPDEEYIGEKIEPYWAEDPVINAAFEVFSGKLKELEGIIDARNNDSKLSNRNGAGVMPYELLKPYSEPGVTGKGVPYSISI

SEQ ID NO: 30 - protein, 861 aa, Unknown
  Potato
MIGQITSGLFGGPDDSKKLKGTVVMMNKNALDFTDLAGSLTDKAFEFLGQTVSFQLISSVQGDPTNGLQGKHSNPAYLENSLFTLTPLTAGSETAFGVTFDWNEEFGVPGAFIIKNTHINEFFLKSLTLEDVPNHGKVHFVCNSWVYPSFRYKSDRIFFVNQPYLPSKTPELLRKYRENELLTLRGDGTGKREAWDRIYDYDIYNDLGNPDEGKENVRTTLGGSAEYPYPRRGRTGRPPTRTDPKSESRIPLILSLDIYVPRDERFGHLKMSDFLTYALKSIVQFILPELHALFDGTPNEFDSFEDVLRLYEGGIKLPQGPLFKALTAAIPLEMIRELLRTDGEGILRFPTPLVIKDSKTAWRTDEEFAREMLAGVNPVIISRLQEFPPKSKLDPEAYGNQNSTITAEHIEDKLDGLTVDEAMNNNKLFILNHHDVLIPYLRRINTTTTKTYASRTLLFLQDNGSLKPLAIELSLPHPDGDQFGVTSKVYTPSDQGVESSIWQLAKAYVAVNDSGVHQLISHWLNTHAVIEPFVIATNRQLSVLHPIHKLLYPHFRDTMNINAMARQILINAGGVLESTVFQSKFAMEMSAVVYKDWVFPDQALPADLVKRGVAVEDSSSPHGVRLLIEDYPYAVDGLEIWSAIKSWVSDYCSFYYGSDEEILKDNELQAWWKELREVGHGDKKNEPWWPEMERPQELIDSCTTIIWIASALHAAVNFGQYPYAGYLPNRPTVSRRFMPEPGTPEYEELKKNPDKAFLKTITAQLQTLLGVSLIEILSRHTTDEIYLGQRESPEWTKDKEPLAAFDKFGKKLTDIEKQIIQRNGDNILTNRSGPVNAPYTLLFPTSEGGLTGKGIPNSVSI

SEQ ID NO: 31 - protein, 914 aa, Unknown
  Potato
MALAKEIMGISLLEKSSSFMNSSSMALFNPNNYHKENHLWFNQQFQGRRNLSRRKAFRQSTMAAISENLIKVVPEKAVRFKVRAVVTVRNKNKEDLKETIVKHLDAFTDKIGRNVTLELISTDMDPNTKGPKKSNQAVLKDWSKKSNLKTERVNYTAEFIVDSNFGNPGAITVTNKHQQEFFLESITIEGFACGPVHFPCNSWVQPKKDHPGKRIFFSNQPYLPDETPAGLKSLRERELRDLRGDGKGVRKLSDRIYDYDIYNDLGNPDKGIDFARPKLGGDDNVPYPRRCRSGRVPTDTDISAESRVEKPNPTYVPRDEQFEESKMNTFSTSRLKAVLHNLIPSLMASISSNNHDFKGFSDIDNLYSKGLLLKLGLQDEVLKKLPLPKVVSSIKEGDLLKYDTPKILSKDKFAWLRDDEFARQAIAGVNPVSIEKLQFFPPVSKLDPEIYGPQESALKEEHILGHLNGMTVQEALDANKLFIVDHHDVYLPFLDRINALDGRKAYATRTIFFLSDVGTLKPIAIELSLPQTGPSSRSKRVVTPPVCATGNWTWQIAKAHVCANDAGVHQLVNHWLRTHASLEPFILAAHRQLSAMHPIYKLLDPHMRYTLEINGLARQSLINADGVIEACFTPGRYCMEISAAAYKNWRFDLEGLPADLIRRGMAVPDSTQPHGLKLLIEDYPYAADGLMIWGAIESWVRDYVNHYYPSSAQVCSDRELQAWYAETINVGHVDLRNEEWWPTLATPEDLISILTTLIWLASAQHAALNFGQYPYGGYVPNRPPLMRRLIPDENDPEYAVFLADPQKYFFSALPSLLQATKFMAVVDTLSTHSPDEEYLGERHQPSTWTGDAEIVEAFYKFSAEIGRIEKEIDERNANTKLKNRCGAGVLPYELLAPSSGPGVTCRGVPNSVSI

SEQ ID NO: 32 - protein, 857 aa, Unknown
  Potato
QIVGGLIGGHHDSKKVKGTVVMMKKNALDFTDLAGSLTDKIFEALGQKVSFQLISSVQSDPANGLQGKHSNPAYLENFLFTLTPLAAGETAFGVTFDWNEEFGVPGAFIIKNTHINEFFLKSLTLEDVPNHGKVHFVCNSWVYPSFRYKSDRIFFANQPYLPSETPELLRKYRENELLTLRGDGTGKREAWDRIYDYDVYNDLGNPDQGEQNVRTTLGGSADYPYPRRGRTGRPPTRTDPKSESRIPLILSLDIYVPRDERFGHLKMSDFLTYALKSIVQFILPELHALFDGTPNEFDSFEDVLRLYEGGIKLPQGPLFKALTAAIPLEMMKELLRTDGEGILRFPTPLVIKDSKTAWRTDEEFAREMLAGVNPIIISRLQEFPPKSKLDPEAYGNQNSTITAEHIEDKLDGLTVDEAMNNNKLFILNHHDVLIPYLRRINTTTTKTYASRTLLFLQDNGSLKPLAIELSLPHPDGDQFGVISKVYTPSDQGVESSIWQLAKAYVAVNDSGVHQLISHWLNTHAVIEPFVIATNRQLSVLHPIHKLLYPHFRDTMNINAMARQILINAGGVLESTVFPSKFAMEMSAVVYKDWVFPDQALPADLVKRGVAVEDSSSPHGVRLLIEDYPYAVDGLEIWSAIKSWVTDYCSFYYGSDEEILKDNELQAWWKELREVGHGDKKNEPWWPEMETPQELIDSCTTIIWIASALHAAVNFGQYPYAGYLPNRPTVSRRFMPEPGTPEYEELKKNPDKAFLKTITAQLQTLLGVSLIEILSRHTTDEIYLGQRESPEWTKDKEPLAAFDKFGKKLTDIEKQIIQRNGDNILTNRSGPVNAPYTLLFPTSEGGLTGKGIPNSVSI

SEQ ID NO: 33 - protein, 862 aa, Unknown
  Potato
MLLEKIVEAISGRSEDNGKKVKGTIVLMKKNVLDFNDVNASLLDGVLEFLGKRVSLQLISVVHADPGNSLQGKRSNPAYLEKWLTTGTSLVAGESAFDVTFDWDEDIGVPGAFIINNFHFNEFYLKSLTLEDVPNHGNVHFVCNSWVYPAKKYKSERIFFANQAYLPGETPEPLRNYREKELVNLRGNGNGKLEEWDRVYDYALYNDLGDPEKGKQYARTILGGSAEYPYPRRGRTGRKPTKADPKSESRIPLLMSLDIYVPRDERFGHIKLSDFLTYALKSIVQFLIPEFQALFDSTPDEFDSFEDVLKLYEGGIKLPQGPFLKALTDSIPLEILKEIIRTDGEGKFKFPTPQVIQEDKSSWRTDEEFAREMLAGVNPVIISRLQEFPPKSQLDSEVYGNQNSTITKEHIENTLDGLTIDDAIKTNRLYILNHHDILMPYVRRINTTNTKLYASRTLLFLQDDGTMKPVAIELSLPHPDGDELGAVSKVYTPADQGVEGSIWQLAKAYVAVNDSGVHQLISHWLNTHAAIEPFVIATNRQLSVLHPIHKLLHPHFRDTMNINALARQILINAGGVLEMTVFPAKYAMEMSAVVYKSWVFPEQALPADLIKRGVAVEDSSSPHGVRLLIQDYPYAVDGLEIWSAIKSWVTEYCNFYYKSDELVLKDNELQAWWKELREEGHGDKKDEPWWPKMQTRQELKDSCTIIIWIASALHAAVNFGQYPYAGYLPNRPTLSRRFMPEPGTPEYEELKTNPDKAYLKTITPQLQTLLGISLIEILSRHASDEIYLGQRDSSEWTKDQEPIAAFERFGKKLSEIEDQIIQMNGDKKWKNRSGPVNVPYTLLFPTSEQGLTGKGIPNSVSI

SEQ ID NO: 34 - protein, 860 aa, Unknown
  Potato
MLGQIVGGLIGGHHDSKKVKGTVVMMKKNALDFTDLAGSLTDKIFEALGQKVSFQLISSVQSDPANGLQGKHSNPAYLENFLFTLTPLAAGETAFGVTFDWNEEFGVPGAFIIKNTHINEFFLKSLTLEDVPNHGKVHFVCNSWVYPSFRYKSDRIFFANQPYLPSETPELLRKYRENELLTLRGDGTGKREAWDRIYDYDVYNDLGNPDQGKENVRTTLGGSADYPYPRRGRTGRPPTRTDPKSESRIPLILSLDIYVPRDERFGHLKMSDFLTYALKSIVQFILPELHALFDGTPNEFDSFEDVLRLYEGGIRLPQGPLFKALTDAIPLEMIRELLRTDGEGILRFPTPLVIKDSKTAWRTDEEFAREMLAGVNPIIISRLQEFPPKSKLDPEAYGNQNSTITAEHIEDKLDGLTVDEAMNNNKLFILNHHDVLIPYLRRINTTTTKTYASRTLLFLQDNGSLKPLAIELSLPHPDGDQFGVTSKVYTPSDQGVESSIWQLAKAYVAVNDSGVHQLISHWLNTHAVIEPFVIATNRQLSVLHPIHKLLYPHFRDTMNINAMARQILINAGGVLESTVFPSKFAMEMSAVVYKDWVFPDQALPADLVKRGVAVEDSSSPHGVRLLIEDYPYAVDGLEIWSAIKSWVTDYCSFYYGSDEEILKDNELQAWWKELREVGHGDKKNEPWWPEMETPQELIDSCTTIIWIASALHAAVNFGQYPYAGYLPNRPTVSRRFMPEPGTPEYEELKKNPDKAFLKTITAQLQTLLGVSLIEILSRHTTDEIYLGQRESPEWTKDKEPLAAFDKFGKKLTDIEKQIIQRNGDNILINRSGPVNAPYTLLFPTSEGGLTGKGIPNSVSI

SEQ ID NO: 35 - protein, 861 aa, Unknown
  Potato
MIGQITSGLFGGHDDSKKVKGTVVMMNKNVLDFTDLAGSLTGKIFDVLGQKVSFQLISSVQGDPTNGLQGKHSNPAYLENSLFTLTPLTAGSETAFGVTFDWNEEFGVPGAFIIKNMHINEFFLKSLTLEDVPNHGKVHFVCNSWVYPSLNYKSDRIFFANQPYLPSETPELLRKYRENELLTLRGDGTGKREAWDRIYDYDIYNDLGNPDQGKENVRTTLGGSAEYPYPRRGRTGRPPTRTDPKSESRIPLILSLDIYVPRDERFGHLKMSDFLTYALKSIVQFILPELHALFDGTPNEFDSFEDVLRLYEGGIKLPQGPLFKALTAAIPLEMIRELLRTDGEGILRFPTPLVIKDSKTAWRTDEEFAREMLAGVNPVIISRLQEFPPKSKLDPEAYGNQNSTITAEHIEDKLDGLTVDEAMNNNKLFILNHHDVIIPYLRRINTTITKAYASRTLLFLQDNGSLKPLAIELSFPHPDGDQFGVTSKVYTPSDQGVESSIWQLAKAYVAVNDVGVHQLISHWLNTHAVIEPFVIATNRQLSVLHPIHKLLYPHFRDTMNINASARQLLVNAGGVLESTVFQSKFAMEMSAVVYKDWVFPDQALPADLVKRGVAVEDSSSPHGVRLLIEDYPYAVDGLEIWSAIKSWVTDYCSFYYGSDEEILKDNELQAWWKELREVGHGDKKNEPWWPEMETPQELIDSCTTIIWIASALHAAVNFGQYPYAGYLPNRPTVSRRFMPEPGTPEYEELKRNPDKAFLKTITAQLQTLLGVSLVEILSRHTTDEIYLGQRESPEWTKDKEPLAAFDRFGKKLTDIEKQIIQRNGDNILTNRSGPVNAPYTLLFPTSEGGLTGKGIPNSVSI

SEQ ID NO: 36 - protein, 861 aa, Unknown
  Potato
MIGQITSGLFGGHDDSKKVKGTVVMMNKNVLDFTDLAGSLTGKIFDVLGQKVSFQLISSVQGDPTNGLQGKHSNPAYLENSLFTLTPLTAGSETAFGVTFDWNEEFGVPGAFIIKNMHINEFFLKSLTLEDVPNHGKVHFVCNSWVYPSLNYKSDRIFFANQPYLPSETPELLRKYRENELLTLRGDGTGKREAWDRIYDYDIYNDLGNPDQGKENVRTTLGGSAEYPYPRRGRTGRPPTRTDPKSESRIPLILSLDIYVPRDERFGHLKMSDFLTYALKSIVQFILPELHALFDGTPNEFDSFEDVLRLYEGRDQLPQGPLFKALTAAIPLEMIRELLRTDGEGILRFPTPLVIKDSKTAWRTDEEFAREMLAGVNPIIISRLQEFPPKSKLDPEAYGNQNSTITAEHIEDKLDGLTVDEAMNNNKLFILNHHDVIIPYLRRINTTITKTYASRTLLFLQDNGSLKPLAIELSLPHPDGDQFGVTSKVYTPSDQGVESSIWQLAKAYVAVNDTGVHQLISHWLNTHAVIEPFVIATNRQLSVLHPIHKLLYPHFRDTMNINASARQILVNAGGVLESTVFQSKFAMEMSAVVYKDWVFPDQALPADLVKRGVAVEDSSSPHGVRLLIEDYPYAVDGLEIWSAIKSWVTDYCSFYYGSDEEILKDNELQAWWKELREVGHGDKKNEPWWPEMKTPQELIDSCTTIIWIASALHAAVNFGQYPYAGYLPNRPTVSRRFMPEPGTPDYEELKRNPDKAFLKTITAQLQTLLGVSLVEILSRHTTDEIYLGQRESPEWTKDKEPLAAFDRFGKKLTDIEKQIIQRNGDNILTNRSGPVNAPYTLLFPTSEGGLTGKGIPNSVSI

SEQ ID NO: 37 - protein, 861 aa, Unknown
  Potato
MIGQITSGLFGGHDDSKKVKGTVVMMNKNVLDFTDLASSLTGKIFDVLGQKVSFQLISSVQGDPTNGLQGKHSNPAYLENSLFTLTPLTAGSETAFGVTFDWNEEFGVPGAFIIKNMHITEFFLKSLTLEDVPNHGKVHFVCNSWVYPSLNYKSDRIFFANQPYLPSDTPELLRKYRENELLTLRGDGTGKREAWDRIYDYDIYNDLGNPDQGKENVRTTLGGSAEYPYPRRGRTGRPPTRTDPKSESRIPLILSTDIYVPRDERFGHLKMSDFLTYALKSIVQFILPELHALFDGTPNEFDSFEDVLRLYEGGIKLPQGPLFKALTAAIPLEMIRELLRTDGEGILRFPTPLVIKDSKTAWRTDEEFAREMLAGTNPVIISRLQEFPPKSKLDPEAYGNQNSTITAEHIEDKLDGLTVDEAMNNNKLFILNHHDLLIPYLRRINTTITKTYASRTLLFLQDNGSLKPLAIELSLPHPDGDQFGVTSKVYTPSDQGVESSIWQLAKAYVAVNDSGVHQLISHWLNTHAVIEPFVIATNRQLSVLHPIHKLLYPHFRDTMNINALARQILINAAGVFESTVFQSKFALEMSAVVYKDWVFPDQALPADLVKRGVAVEDSSSPHGVRLLIEDYPYAVDGLEIWSAIKSWVTDYCSFYYGSDEEILKDNELQAWWKELREVGHGDKKNEPWWPEMETPQELIDSCTTIIWIASALHAAVNFGQYPYAGYLPNRATVSRRFMPEPGTPEYEELKKNPDKAFLKTITAQLQTLLGVSLVEILSRHTTDEIYLGQRESPEWTKDKEPLAAFDRFGKKLTDIEKQIIQRNGDNILTNRSGPVNAPYTLLFPTSEGGLTGKGIPNSVSI

SEQ ID NO: 38 - protein, 861 aa, Unknown
  Potato
MIGQITSGLFGGHDDSKKVKGTVVMMNKNVLDFTDLASSLTGKIFDVLGQKVSFQLISSVQGDPTNGLQGKHSNPAYLENSLFTLTPLTAGSETAFGVTFDWNEEFGVPGAFIIKNMHITEFFLKSLTLEDVPNHGKVHFVCNSWVYPSLNYKSDRIFFANQPYLPSETPELLRKYRENELLTLRGDGTGKREAWDRIYDYDIYNDLGNPDQGKENVRTTLGGSAEYPYPRRGRTGRPPTRTDPKVKSRIPLILSLDIYVPRDERFGHLKMSDFLTYALKSIVQFILPELHALFDGTPNEFDSFEDVLRLYEGGIKLPQGPLFKALTAAIPLEMIRELLRTDGEGILRFPTPLVIKDSKTAWRTDEEFAREMLAGVNPIIISRLQEFPPKSKLDPEAYGNQNSTITAEHIEDKLDGLTVDEAMNNNKLFILNHHDVIIPYLRRINTTITKTYASRTLLFLQDNGSLKPLAIELSLPHPDGDQFGVTSKVYTPTDQGVESSIWQLAKAYVAVNDTGVHQLISHWLNTHAVIEPFVIATNRQLSVLHPIHKLLYPHFRDTMNINASARQILVNAGGVLESTVFQSKFAMEMSAVVYKDWVFPDQALPADLVKRGVAVEDSSSPHGVRLLIEDYPYAVDGLEIWSAIKSWVTDYCSFYYGSDEEILKDNELQAWWKELREVGHGDKKNEPWWPEMKTPQELIDSCTTIIWIASALHAAVNFGQYPYAGYLPNRPTVSRRFMPEPGTPEYEELKRNPDKAFLKTITAQLQTLLGVSLVEILSRHTTDEIYLGQRESPEWTKDKEPLAAFDRFGKKLTDIEKQIIQRNGDNILTNRSGPVNAPYTLLFPTSEGGLTGKGIPNSVSI